(19) United States
(12) Patent Application Publication
(10) Pub. No.: US 2026/0296001 A1
(43) Pub. Date: Oct. 1, 2026

(54) Head Unit And Liquid Ejecting Apparatus

(71) Applicant: SEIKO EPSON CORPORATION, Tokyo (JP)

(72) Inventor: Tadashi HAYASHI, Matsumoto (JP)

(21) Appl. No.: 19/577,556

(22) Filed: Mar. 25, 2026

(30) Foreign Application Priority Data
Mar. 26, 2025 (JP) 2025-051801

(51) Int. Cl. B41J 2/045

(52) U.S. Cl. CPC B41J 2/04573; B41J 2/04581

(57) ABSTRACT

A head unit includes a head control circuit that controls an ejecting head which ejects a liquid by driving a drive element, and a drive signal output circuit which outputs a drive signal, and that has a first mode in which the head control circuit controls the ejecting head and the drive signal output circuit in a cycle defined by the ejection timing signal, and a second mode in which the head control circuit controls the ejecting head and the drive signal output circuit in a cycle defined by an internal ejection timing signal corresponding to a clock signal, when the ejection timing signal is not input for a predetermined period in the first mode, the head control circuit transitions to the second mode, and when the ejection timing signal is input in the second mode, the head control circuit transitions to the first mode.

The present application is based on, and claims priority from JP Application Serial Number 2025-051801, filed Mar. 26, 2025, the disclosure of which is hereby incorporated by reference herein in its entirety.

### BACKGROUND

### 1. Technical Field

The present disclosure relates to a head unit and a liquid ejecting apparatus.

### 2. Related Art

A liquid ejecting apparatus, such as one according to JP-A-2023-030330, including an ejecting unit (head unit) that includes a liquid ejecting module (printhead) which ejects a liquid to a medium, and a control unit that is attachable to the ejecting unit and controls an operation of the ejecting unit is known as a liquid ejecting apparatus that ejects a liquid to a medium.

In a liquid ejecting apparatus 1 such as one according to JP-A-2023-030330, an issue that arises when the number of head units coupled to the control unit increases is not sufficiently addressed, and there is room for improvement.

### SUMMARY

According to an aspect of the present disclosure, a head unit coupled to an external controller that outputs an ejection timing signal includes an ejecting head that includes a drive element driven in accordance with a drive signal and ejects a liquid by driving the drive element, a drive signal output circuit that outputs the drive signal, and a head control circuit that controls the ejecting head and the drive signal output circuit, in which the head control circuit has a first mode in which the head control circuit controls the ejecting head and the drive signal output circuit in a cycle defined by the ejection timing signal, and a second mode in which the head control circuit controls the ejecting head and the drive signal output circuit in a cycle defined by an internal ejection timing signal corresponding to a clock signal, when the ejection timing signal is not input for a predetermined period in the first mode, the head control circuit transitions to the second mode, and when the ejection timing signal is input in the second mode, the head control circuit transitions to the first mode.

According to another aspect of the present disclosure, a liquid ejecting apparatus includes a control unit that outputs an ejection timing signal, and a head unit coupled to the control unit, in which the head unit includes an ejecting head that includes a drive element driven in accordance with a drive signal and ejects a liquid by driving the drive element, a drive signal output circuit that outputs the drive signal, and a head control circuit that controls the ejecting head and the drive signal output circuit, the head control circuit has a first mode in which the head control circuit controls the ejecting head and the drive signal output circuit in a cycle defined by the ejection timing signal, and a second mode in which the head control circuit controls the ejecting head and the drive signal output circuit in a cycle defined by an internal ejection timing signal corresponding to a clock signal, when the ejection timing signal is not input for a predetermined period in the first mode, the head control circuit transitions to the second mode, and when the ejection timing signal is input in the second mode, the head control circuit transitions to the first mode.

### BRIEF DESCRIPTION OF THE DRAWINGS

FIG. 1 is a diagram showing a schematic configuration of a liquid ejecting apparatus.

FIG. 2 is a diagram showing a schematic configuration of a head unit.

FIG. 3 is a diagram showing a schematic configuration of an ejecting portion.

FIG. 4 is a diagram showing an example of signal waveforms of drive signals.

FIG. 5 is a diagram showing a functional configuration of a drive signal selection circuit.

FIG. 6 is a diagram showing an example of decoded contents in a decoder.

FIG. 7 is a diagram showing an example of a configuration of a selection circuit.

FIG. 8 is a diagram for describing an operation of the drive signal selection circuit.

FIG. 9 is a diagram showing an example of a configuration in which the head unit has an operation mode in which the head unit individually executes a sequence control, and an operation mode in which the head unit operates in synchronization with a timing signal.

FIG. 10 is a diagram showing an example of a data configuration of the drive control signal.

FIG. 11 is a diagram showing an example of a data configuration of an internal drive control signal.

FIG. 12 is a diagram showing an example of a relationship between waveform selection information and waveform information stored in a storage circuit.

FIG. 13 is a diagram showing an example of an operation of the configuration in which the head unit has the operation mode in which the head unit individually executes the sequence control, and the operation mode in which the head unit operates in synchronization with the timing signal.

### DESCRIPTION OF EMBODIMENTS

Hereinafter, preferred embodiments of the present disclosure will be described with reference to the drawings. The drawings are used for convenience of description. The embodiments described below do not unduly limit the contents of the present disclosure according to the claims. In addition, not all configurations described below are essential requirements of the present disclosure.

### 1. Schematic Configuration and Operation of Liquid Ejecting Apparatus

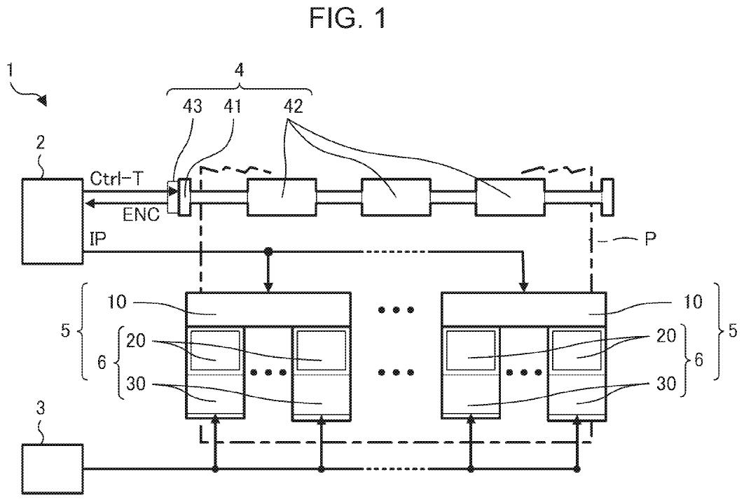

FIG. 1 is a diagram showing a schematic configuration of a liquid ejecting apparatus 1. As shown in FIG. 1, the liquid ejecting apparatus 1 is a so-called line-type ink jet printer that forms a desired image on a medium P transported by a transport unit 4 by ejecting an ink that is an example of a liquid, to the medium P at a desired timing. In the following description, a direction in which the medium P is transported may be referred to as a transport direction, and a width direction of the medium P being transported may be referred to as a main scanning direction.

As shown in FIG. 1, the liquid ejecting apparatus 1 includes a control unit 2, a liquid container 3, the transport unit 4, and a plurality of head units 5.

The control unit 2 includes a processing circuit such as a central processing unit (CPU) or a field programmable gate array (FPGA), and a storage circuit such as a semiconductor memory. The control unit 2 outputs a signal for controlling each element of the liquid ejecting apparatus 1 based on image data supplied from an external device such as a host computer, not shown, provided outside the liquid ejecting apparatus 1 and on an encoder signal ENC, which will be described later.

The liquid container 3 stores the ink as an example of the liquid supplied to the head units 5. Specifically, for example, the liquid container 3 stores inks of a plurality of colors, such as inks of black, cyan, magenta, and yellow, to be ejected to the medium P.

The transport unit 4 includes a transport motor 41, a transport roller 42, and an encoder 43. The transport unit 4 receives input of a transport control signal Ctrl-T output by the control unit 2. The transport motor 41 operates based on the transport control signal Ctrl-T, and the transport roller 42 is rotationally driven in connection with the operation of the transport motor 41. Accordingly, the medium P is transported along the transport direction. The encoder 43 generates the encoder signal ENC corresponding to a transport position of the medium P by detecting a rotation angle of at least one of the transport motor 41 or the transport roller 42, and outputs the encoder signal ENC to the control unit 2.

The plurality of head units 5 are configured to be attachable and interchangeable with respect to the liquid ejecting apparatus 1 and the control unit 2, and each of them includes a relay unit 10 and a plurality of ejecting units 6. Each of the plurality of ejecting units 6 includes a head drive module 20 and a liquid ejecting module 30. The head unit 5 receives input of an image information signal IP output by the control unit 2 and is supplied with the ink stored in the liquid container 3. The relay unit 10 and the plurality of head drive modules 20 control the plurality of liquid ejecting modules 30 based on the image information signal IP. The liquid ejecting module 30 ejects the ink supplied from the liquid container 3 to the medium P under control of the relay unit 10 and the plurality of head drive modules 20.

The liquid ejecting apparatus 1 of the present embodiment constitutes a line-type ink jet printer. Specifically, the plurality of liquid ejecting modules 30 are provided to extend over a width of the medium P or longer in the width direction which is the main scanning direction and intersects with the transport direction of the medium P being transported, so that the inks can be ejected to a whole region, in the width direction, of the medium P being transported. The ink is ejected from each of the plurality of liquid ejecting modules 30 in connection with the transport of the medium P, and the ink lands at a desired position on the medium P. Accordingly, a desired image is formed on the medium P.

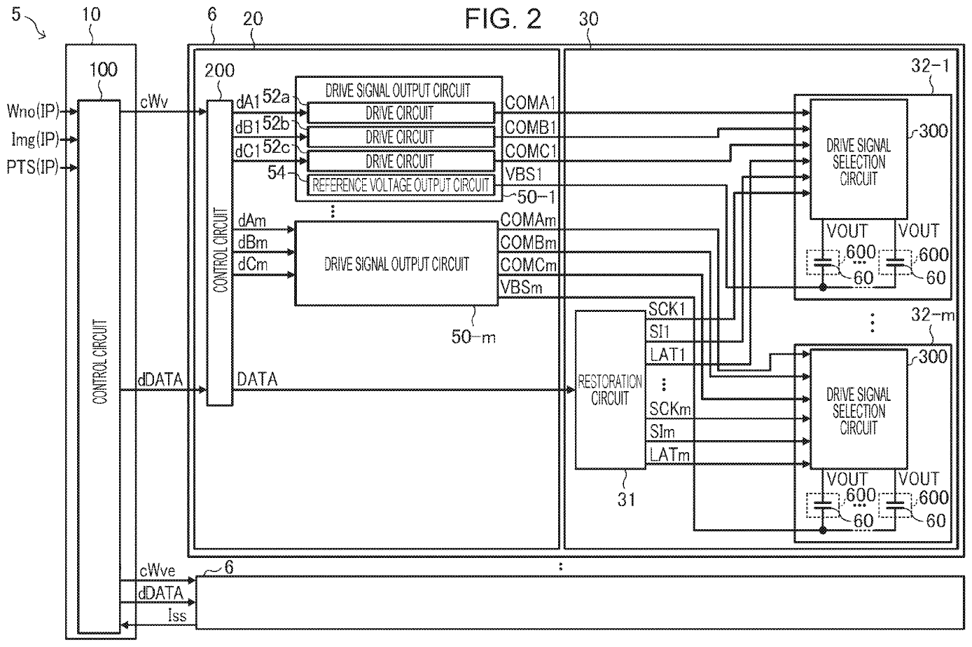

Next, a schematic configuration of the head unit 5 will be described. FIG. 2 is a diagram showing a schematic configuration of the head unit 5. As shown in FIG. 2, the head unit 5 includes the relay unit 10 and the ejecting unit 6. The ejecting unit 6 includes the head drive module 20 and the liquid ejecting module 30. Electrical coupling is made between the relay unit 10 and the ejecting unit 6 and between the head drive module 20 and the liquid ejecting module 30 by, for example, flexible printed circuits (FPC), a flexible flat cable (FFC), or a board to board (BtoB) connector.

The relay unit 10 includes a control circuit 100. The control circuit 100 receives input of an image data signal Img corresponding to the image data, a drive control signal Wno, and a timing signal PTS corresponding to the encoder signal ENC as the image information signal IP. The control circuit 100 generates a waveform selection signal cWv corresponding to each of the plurality of ejecting units 6 based on the timing signal PTS and the drive control signal Wno, and outputs the waveform selection signal cWv to the corresponding ejecting unit 6. The control circuit 100 also generates base data signal dDATA corresponding to each of the plurality of ejecting units 6 based on the timing signal PTS and the image data signal Img, and outputs the base data signal dDATA to the corresponding ejecting unit 6.

All of the plurality of ejecting units 6 have the same configuration. Thus, one ejecting unit 6 will be used for description, and other ejecting units 6 will not be shown or described. The ejecting unit 6 includes the head drive module 20 and the liquid ejecting module 30. The head drive module 20 includes a control circuit 200 and drive signal output circuits 50-1 to 50-m.

The control circuit 200 includes a CPU, an FPGA, or the like. The control circuit 200 receives input of the waveform selection signal cWv and the base data signal dDATA output by the control circuit 100.

The control circuit 200 converts the base data signal dDATA into a differential signal of low voltage differential signaling (LVDS) or the like, and outputs the differential signal to the liquid ejecting module 30 as a data signal DATA. The control circuit 200 may convert the base data signal dDATA into a differential signal of a high-speed transmission method, such as low voltage positive emitter coupled logic (LVPECL) or current mode logic (CML), other than LVDS, and output the differential signal to the liquid ejecting module 30 as the data signal DATA. Alternatively, the control circuit 200 may output a part or a whole of the base data signal dDATA to the liquid ejecting module 30 as a single-ended data signal DATA.

The control circuit 200 also generates base drive signals dA1, dB1, and dC1 corresponding to the waveform selection signal cWv, and outputs the base drive signals dA1, dB1, and dC1 to the drive signal output circuit 50-1. The drive signal output circuit 50-1 includes drive circuits 52a, 52b, and 52c. The drive circuit 52a receives input of the base drive signal dA1. The drive circuit 52a generates a drive signal COMA1 by performing digital/analog conversion and then class-D amplification on the input base drive signal dA1, and outputs the drive signal COMA1 to the liquid ejecting module 30. The drive circuit 52b receives input of the base drive signal dB1. The drive circuit 52b generates a drive signal COMB1 by performing digital/analog conversion and then class-D amplification on the input base drive signal dB1, and outputs the drive signal COMB1 to the liquid ejecting module 30. The drive circuit 52c receives input of the base drive signal dC1. The drive circuit 52c generates a drive signal COMC1 by performing digital/analog conversion and then class-D amplification on the input base drive signal dC1, and outputs the drive signal COMC1 to the liquid ejecting module 30.

Each of the drive circuits 52a, 52b, and 52c only needs to generate the drive signals COMA1, COMB1, and COMC1 by amplifying waveforms defined by each of the input base drive signals dA1, dB1, and dC1. Thus, each of the drive circuits 52a, 52b, and 52c may include a class-A amplifier circuit, a class-B amplifier circuit, a class-AB amplifier circuit, or the like instead of a class-D amplifier circuit or in addition to a class-D amplifier circuit. In addition, the base drive signals dA1, dB1, and dC1 only need to define the waveforms of the corresponding drive signals COMA1, COMB1, and COMC1, respectively, and may be analog signals.

The drive signal output circuit 50-1 also includes a reference voltage output circuit 54. The reference voltage output circuit 54 generates a reference voltage signal VBS1 having a constant potential indicating a reference potential of a piezoelectric element 60, which will be described later, included in the liquid ejecting module 30, and outputs the reference voltage signal VBS1 to the liquid ejecting module 30. The reference voltage signal VBS1 may be, for example, a ground potential or a constant potential such as 5.5 V or 6 V. A constant potential includes a substantially constant potential after taking into consideration error such as a change in potential caused by an operation of a peripheral circuit, a change in potential caused by a variation in a circuit element, or a change in potential caused by a temperature characteristic of a circuit element.

The drive signal output circuits 50-2 to 50-m have the same configuration as the drive signal output circuit 50-1 except that input signals and output signals are different. The control circuit 200 generates base drive signals dAj, dBj, and dCj (j is any of 1 to m) corresponding to the waveform selection signal cWv, and outputs the base drive signals dAj, dBj, and dCj to a drive signal output circuit 50-j. The drive signal output circuit 50-j includes circuits corresponding to the drive circuits 52a, 52b, and 52c, and a circuit corresponding to the reference voltage output circuit 54. The drive signal output circuit 50-j generates drive signals COMAj, COMBj, and COMCj and a reference voltage signal VBSj based on the input base drive signals dAj, dBj, and dCj, and outputs the drive signals COMAj, COMBj, and COMCj and the reference voltage signal VBSj to the liquid ejecting module 30.

The liquid ejecting module 30 includes a restoration circuit 31, ejecting modules 32-1 to 32-m, and state acquisition circuits 33-1 to 33-m.

The restoration circuit 31 restores the data signal DATA to a single-ended signal, separates the single-ended signal into signals corresponding to each of the ejecting modules 32-1 to 32-m, and outputs the separated signals to the corresponding ejecting modules 32-1 to 32-m.

Specifically, the restoration circuit 31 generates a clock signal SCK1, a print data signal SI1, and a latch signal LAT1 corresponding to the ejecting module 32-1 by restoring and separating the data signal DATA, and outputs the clock signal SCK1, the print data signal SI1, and the latch signal LAT1 to the ejecting module 32-1. The restoration circuit 31 also generates a clock signal SCKj, a print data signal SIj, and a latch signal LATj corresponding to an ejecting module 32-j by restoring and separating the data signal DATA, and outputs the clock signal SCKj, the print data signal SIj, and the latch signal LATj to the ejecting module 32-j.

As described above, the restoration circuit 31 restores the data signal DATA of the differential signal output by the head drive module 20, and separates the restored signal into signals corresponding to the ejecting modules 32-1 to 32-m. Accordingly, the restoration circuit 31 generates clock signals SCK1 to SCKm, print data signals SI1 to SIm, and latch signals LAT1 to LATm corresponding to the ejecting modules 32-1 to 32-m, and outputs the clock signals SCK1 to SCKm, the print data signals SI1 to SIm, and the latch signals LAT1 to LATm to the corresponding ejecting modules 32-1 to 32-m. One of the clock signals SCK1 to SCKm, the print data signals SI1 to SIm, or the latch signals LAT1 to LATm corresponding to each of the ejecting modules 32-1 to 32-m output by the restoration circuit 31 may be a common signal corresponding to the ejecting modules 32-1 to 32-m.

According to the point of generating the clock signals SCK1 to SCKm, the print data signals SI1 to SIm, and the latch signals LAT1 to LATm by restoring and separating the data signal DATA via the restoration circuit 31, the data signal DATA output by the control circuit 200 is a differential signal corresponding to the clock signals SCK1 to SCKm, the print data signals SI1 to SIm, and the latch signals LAT1 to LATm, and the base data signal dDATA as a base of the data signal DATA includes signals corresponding to each of the clock signals SCK1 to SCKm, the print data signals SI1 to SIm, and the latch signals LAT1 to LATm.

The ejecting module 32-1 includes a drive signal selection circuit 300 and a plurality of ejecting portions 600. Each of the plurality of ejecting portions 600 includes the piezoelectric element 60.

The ejecting module 32-1 receives input of the drive signals COMA1, COMB1, and COMC1, the reference voltage signal VBS1, the clock signal SCK1, the print data signal SI1, and the latch signal LAT1. The drive signal selection circuit 300 included in the ejecting module 32-1 receives input of the drive signals COMA1, COMB1, and COMC1, the clock signal SCK1, the print data signal SI1, and the latch signal LAT1. The drive signal selection circuit 300 generates a drive signal VOUT by selecting or not selecting each of the drive signals COMA1, COMB1, and COMC1 based on the input clock signal SCK1, print data signal SI1, and latch signal LAT1, and supplies the drive signal VOUT to one end of the piezoelectric element 60 included in the corresponding ejecting portion 600. The other end of the piezoelectric element 60 is supplied with the reference voltage signal VBS1. The piezoelectric element 60 is driven by a difference in potential between the drive signal VOUT supplied to its one end and the reference voltage signal VBS1 supplied to its other end. Accordingly, the ink is ejected from the corresponding ejecting portion 600.

The ejecting module 32-j also includes the drive signal selection circuit 300 and the plurality of ejecting portions 600. Each of the plurality of ejecting portions 600 includes the piezoelectric element 60.

The ejecting module 32-j receives input of the drive signals COMAj, COMBj, and COMCj, the reference voltage signal VBSj, the clock signal SCKj, the print data signal SIj, and the latch signal LATj. The drive signal selection circuit 300 included in the ejecting module 32-j receives input of the drive signals COMAj, COMBj, and COMCj, the clock signal SCKj, the print data signal SIj, and the latch signal LATj. The drive signal selection circuit 300 generates the drive signal VOUT by selecting or not selecting each of the drive signals COMAj, COMBj, and COMCj based on the input clock signal SCKj, print data signal SIj, and latch signal LATj, and supplies the drive signal VOUT to one end of the piezoelectric element 60 included in the corresponding ejecting portion 600. The other end of the piezoelectric element 60 is supplied with the reference voltage signal VBSj. The piezoelectric element 60 is driven by a difference in potential between the drive signal VOUT supplied to its one end and the reference voltage signal VBSj supplied to its other end. Accordingly, the ink is ejected from the corresponding ejecting portion 600.

As described above, in the liquid ejecting apparatus 1 of the present embodiment, the control unit 2 controls the transport of the medium P by the transport unit 4 and the ejection of the ink from the liquid ejecting module 30 included in the head unit 5, based on the image data supplied from the host computer or the like, not shown. Accordingly, the liquid ejecting apparatus 1 can cause a desired amount of the ink to land at a desired position on the medium P. Therefore, a desired image is formed on the medium P.

That is, the liquid ejecting apparatus 1 of the present embodiment includes the control unit 2 that outputs the timing signal PTS, and the head unit 5 coupled to the control unit 2. The head unit 5 includes the liquid ejecting module 30 that includes the ejecting modules 32-1 to 32-m which include the piezoelectric element 60 driven in accordance with drive signals COMA, COMB, and COMC and eject an ink that is an example of the liquid, by driving the piezoelectric element 60, the drive signal output circuits 50-1 to 50-m that output the drive signals COMA1 to COMAm, COMB1 to COMBm, and COMC1 to COMCm, and the control circuits 100 and 200 that control the liquid ejecting module 30 including the ejecting modules 32-1 to 32-m, and the drive signal output circuits 50-1 to 50-m.

The ejecting modules 32-1 to 32-m included in the liquid ejecting module 30 have the same configuration except that input signals are different. Thus, in the following description, the ejecting modules 32-1 to 32-m may be simply referred to as an ejecting module 32 unless otherwise necessary to distinguish therebetween. In this case, the drive signals COMA1 to COMAm input into the ejecting module 32 may be referred to as the drive signal COMA. The drive signals COMB1 to COMBm input into the ejecting module 32 may be referred to as the drive signal COMB. The drive signals COMC1 to COMCm input into the ejecting module 32 may be referred to as the drive signal COMC. The reference voltage signals VBS1 to VBSm input into the ejecting module 32 may be referred to as a reference voltage signal VBS. The clock signals SCK1 to SCKm input into the ejecting module 32 may be referred to as a clock signal SCK. The print data signals SI1 to SIm input into the ejecting module 32 may be referred to as a print data signal SI. The latch signals LAT1 to LATm input into the ejecting module 32 may be referred to as a latch signal LAT. In addition, the drive signal output circuits 50-1 to 50-m have the same configuration except that input signals are different. Thus, in the following description, the drive signal output circuits 50-1 to 50-m may be simply referred to as a drive signal output circuit 50 unless otherwise necessary to distinguish therebetween. In this case, the drive signal output circuit 50 receives input of a base drive signal dA as the base drive signals dA1 to dAm, a base drive signal dB as the base drive signals dB1 to dBm, and a base drive signal dC as the base drive signals dC1 to dCm. The drive signal output circuit 50 outputs the drive signal COMA as the drive signals COMA1 to COMAm, the drive signal COMB as the drive signals COMB1 to COMBm, the drive signal COMC as the drive signals COMC1 to COMCm, and the reference voltage signal VBS as the reference voltage signals VBS1 to VBSm.

### 2. Configuration and Operation of Ejecting Module

### 2.1 Configuration of Ejecting Portion

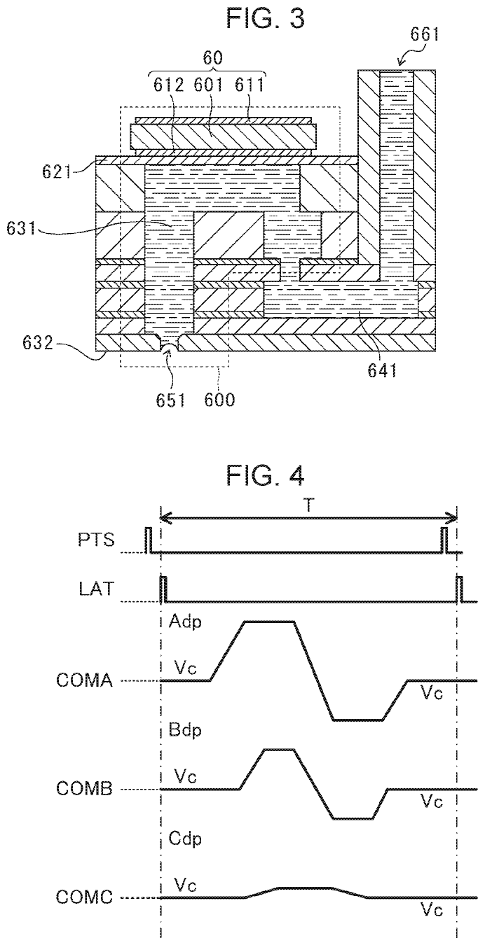

FIG. 3 is a diagram showing a schematic configuration of one of the plurality of ejecting portions 600 included in the ejecting module 32. As shown in FIG. 3, the ejecting portion 600 includes the piezoelectric element 60, a vibrating plate 621, a cavity 631, and a nozzle 651.

The cavity 631 is filled with the ink supplied from a reservoir 641. The ink is poured into the reservoir 641 from the liquid container 3 via an ink tube, not shown, and a supply port 661. That is, the cavity 631 is filled with the ink supplied from the liquid container 3. The vibrating plate 621 is displaced by driving the piezoelectric element 60 provided on its upper surface in FIG. 3. An internal volume of the cavity 631 expands or reduces in connection with the displacement of the vibrating plate 621. The nozzle 651 is an open hole portion that is provided in a nozzle plate 632 and communicates with the cavity 631. The internal volume of the cavity 631 changes in connection with a change in the vibrating plate 621. Accordingly, an amount of the ink corresponding to a change in the internal volume of the cavity 631 is ejected from the nozzle 651. The piezoelectric element 60 includes a piezoelectric body 601 and a pair of electrodes 611 and 612. The pair of electrodes 611 and 612 are provided such that the piezoelectric body 601 is sandwiched therebetween. The piezoelectric body 601 bends in a top-to-bottom direction together with the vibrating plate 621 in accordance with a difference in potential between voltages supplied to the electrodes 611 and 612.

In the ejecting portion 600 configured as described above, when the piezoelectric element 60 bends upward, the vibrating plate 621 is displaced upward, and the internal volume of the cavity 631 expands. Accordingly, the ink stored in the reservoir 641 is drawn into the cavity 631. On the other hand, when the piezoelectric element 60 bends downward, the vibrating plate 621 is displaced downward, and the internal volume of the cavity 631 reduces. Accordingly, an amount of the ink corresponding to a degree of the reduction is ejected from the nozzle 651. The piezoelectric element 60 included in the ejecting portion 600 is not limited to having a structure of flexural vibration as shown in FIG. 3, and may have, for example, a structure of longitudinal vibration.

### 2.2 Functional Configuration of Drive Signal Selection Circuit

Next, a configuration and an operation of the drive signal selection circuit 300 included in the ejecting module 32 will be described. In describing the configuration and the operation of the drive signal selection circuit 300 included in the ejecting module 32, first, an example of signal waveforms included in the drive signals COMA, COMB, and COMC input into the drive signal selection circuit 300 will be described.

FIG. 4 is a diagram showing an example of the signal waveforms of the drive signals COMA, COMB, and COMC. As shown in FIG. 4, the drive signal COMA includes a trapezoidal waveform Adp arranged in a cycle T from a rise of the latch signal LAT to a subsequent rise of the latch signal LAT. The trapezoidal waveform Adp is a signal waveform that is supplied to one end of the piezoelectric element 60 to eject a predetermined amount of the ink from the ejecting portion 600 corresponding to the piezoelectric element 60. The drive signal COMB includes a trapezoidal waveform Bdp arranged in the cycle T. The trapezoidal waveform Bdp is a signal waveform that has a lower voltage amplitude than the trapezoidal waveform Adp and is supplied to one end of the piezoelectric element 60 to eject a smaller amount of the ink than the predetermined amount from the ejecting portion 600 corresponding to the piezoelectric element 60. The drive signal COMC includes a trapezoidal waveform Cdp arranged in the cycle T. The trapezoidal waveform Cdp is a signal waveform that has a lower voltage amplitude than the trapezoidal waveforms Adp and Bdp and is supplied to one end of the piezoelectric element 60 to vibrate the ink near the open hole portion of the nozzle to an extent that the ink is not ejected from the ejecting portion 600 corresponding to the piezoelectric element 60. The trapezoidal waveform Cdp is supplied to the piezoelectric element 60 to vibrate the ink near the open hole portion of the nozzle of the ejecting portion 600 including the piezoelectric element 60. Accordingly, viscosity of the ink near the open hole portion of the nozzle is less likely to increase.

At a start timing and an end timing of each of the trapezoidal waveforms Adp, Bdp, and Cdp, all of the trapezoidal waveforms Adp, Bdp, and Cdp have a common voltage value corresponding to a voltage Vc. That is, each of the trapezoidal waveforms Adp, Bdp, and Cdp is a signal waveform that starts at the voltage Vc and ends at the voltage Vc. The voltage Vc at the start timing and the end timing of each of the trapezoidal waveforms Adp, Bdp, and Cdp may be referred to as an intermediate potential.

In the following description, an amount of the ink ejected from the ejecting portion 600 corresponding to the piezoelectric element 60 when the trapezoidal waveform Adp is supplied to one end of the piezoelectric element 60 may be referred to as a large amount. An amount of the ink ejected from the ejecting portion 600 corresponding to the piezoelectric element 60 when the trapezoidal waveform Bdp is supplied to one end of the piezoelectric element 60 may be referred to as a small amount. Vibrating the ink near the open hole portion of the nozzle to the extent that the ink is not ejected from the ejecting portion 600 corresponding to the piezoelectric element 60 when the trapezoidal waveform Cdp is supplied to one end of the piezoelectric element 60 may be referred to as microvibration.

The signal waveforms included in the drive signals COMA, COMB, and COMC are not limited to the signal waveforms shown in FIG. 4, and various signal waveforms may be used in accordance with a type of the ink ejected from the ejecting portion 600, the number of piezoelectric elements 60 driven by the drive signals COMA, COMB, and COMC, a length of wiring through which the drive signals COMA, COMB, and COMC propagate, the temperature of the ejecting module 32 including the ejecting portion 600, and the like. That is, the drive signals COMA1 to COMAm may have different signal waveforms from each other, the drive signals COMB1 to COMBm may have different signal waveforms from each other, and the drive signals COMC1 to COMCm may have different signal waveforms from each other.

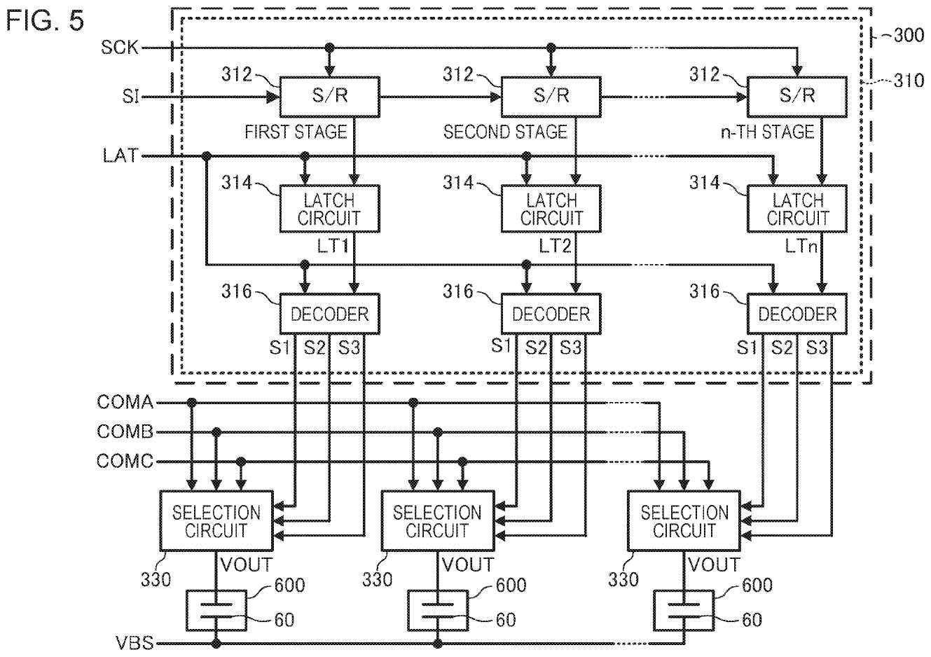

Next, a configuration and an operation of the drive signal selection circuit 300 that outputs the drive signal VOUT by selecting or not selecting each of the drive signals COMA, COMB, and COMC will be described. FIG. 5 is a diagram showing a functional configuration of the drive signal selection circuit 300. As shown in FIG. 5, the drive signal selection circuit 300 includes a selection control circuit 310 and a plurality of selection circuits 330.

The selection control circuit 310 receives input of the print data signal SI, the latch signal LAT, and the clock signal SCK. The selection control circuit 310 includes a set of a shift register (S/R) 312, a latch circuit 314, and a decoder 316 corresponding to each of n ejecting portions 600. That is, the drive signal selection circuit 300 includes n shift registers 312, n latch circuits 314, and n decoders 316 corresponding to the total number of ejecting portions 600.

The print data signal SI is a signal synchronized with the clock signal SCK and includes 2-bit print data [SIH, SIL] for defining a dot size to be formed by the ink ejected from each of the n ejecting portions 600 as one of “large dot LD”, “small dot SD”, “no ejection ND”, and “microvibration BSD”. The print data signal SI is held in the shift register 312 corresponding to the ejecting portion 600 for each 2-bit print data [SIH, SIL].

Specifically, the n shift registers 312 corresponding to the ejecting portions 600 are coupled to each other in a cascade manner. The print data signal SI that is serially input is sequentially transmitted to a subsequent stage of the shift registers 312 coupled in a cascade manner, in accordance with the clock signal SCK. When the supply of the clock signal SCK stops, the n shift registers 312 hold the 2-bit print data [SIH, SIL] corresponding to the ejecting portions 600 corresponding to the shift registers 312. For distinction, FIG. 5 shows the n shift registers 312 coupled in a cascade manner as a first stage, a second stage, . . . , an n-th stage from an upstream point at which the print data signal SI is input, to a downstream point.

Each of the n latch circuits 314 simultaneously latches the 2-bit print data [SIH, SIL] held by the corresponding shift register 312 at a rise of the latch signal LAT.

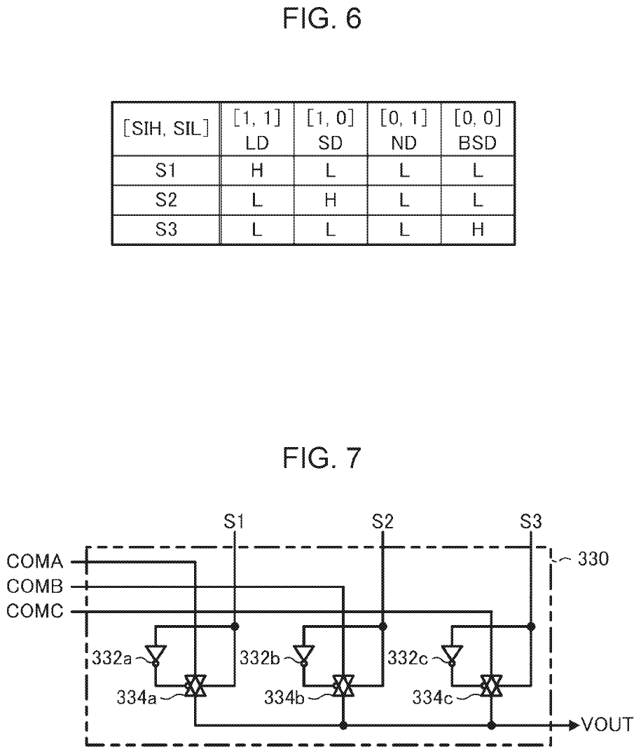

Each of the n decoders 316 decodes the 2-bit print data [SIH, SIL] latched by the corresponding latch circuit 314, and outputs selection signals S1, S2, and S3 having logic levels corresponding to decoded contents, for each cycle T. FIG. 6 is a diagram showing an example of the decoded contents in the decoder 316. The decoder 316 outputs the selection signals S1, S2, and S3 having logic levels defined by the latched 2-bit print data [SIH, SIL] and the decoded contents shown in FIG. 6. For example, when the 2-bit print data [SIH, SIL] latched by the corresponding latch circuit 314 is [1, 0], the decoder 316 sets the logic levels of the selection signals S1, S2, and S3 to levels L, H, and L, respectively, in the cycle T.

The selection circuit 330 is provided in accordance with each of the n ejecting portions 600. That is, the drive signal selection circuit 300 includes n selection circuits 330. The selection circuit 330 receives input of the selection signals S1, S2, and S3 output by the decoder 316 corresponding to the same ejecting portion 600 and the drive signals COMA, COMB, and COMC. The selection circuit 330 generates the drive signal VOUT by selecting or not selecting each of the drive signals COMA, COMB, and COMC based on the selection signals S1, S2, and S3 and the drive signals COMA, COMB, and COMC, and outputs the drive signal VOUT to the corresponding ejecting portion 600.

FIG. 7 is a diagram showing an example of a configuration of the selection circuit 330 corresponding to one ejecting portion 600. As shown in FIG. 7, the selection circuit 330 includes inverters 332a, 332b, and 332c and transfer gates 334a, 334b, and 334c.

The selection signal S1 is input into a positive control terminal not marked with a circle in the transfer gate 334a, and is logically inverted by the inverter 332a and is input into a negative control terminal marked with a circle in the transfer gate 334a. An input terminal of the transfer gate 334a is supplied with the drive signal COMA. In the transfer gate 334a, the input terminal and an output terminal are conductive to each other when the input selection signal S1 is at level H, and the input terminal and the output terminal are not conductive to each other when the input selection signal S1 is at level L. That is, the transfer gate 334a outputs the drive signal COMA to the output terminal when the selection signal S1 is at level H, and does not output the drive signal COMA to the output terminal when the selection signal S1 is at level L.

The selection signal S2 is input into a positive control terminal not marked with a circle in the transfer gate 334b, and is logically inverted by the inverter 332b and is input into a negative control terminal marked with a circle in the transfer gate 334b. An input terminal of the transfer gate 334b is supplied with the drive signal COMB. In the transfer gate 334b, the input terminal and an output terminal are conductive to each other when the input selection signal S2 is at level H, and the input terminal and the output terminal are not conductive to each other when the input selection signal S2 is at level L. That is, the transfer gate 334b outputs the drive signal COMB to the output terminal when the selection signal S2 is at level H, and does not output the drive signal COMB to the output terminal when the selection signal S2 is at level L.

The selection signal S3 is input into a positive control terminal not marked with a circle in the transfer gate 334c, and is logically inverted by the inverter 332c and is input into a negative control terminal marked with a circle in the transfer gate 334c. An input terminal of the transfer gate 334c is supplied with the drive signal COMC. In the transfer gate 334c, the input terminal and an output terminal are conductive to each other when the input selection signal S3 is at level H, and the input terminal and the output terminal are not conductive to each other when the input selection signal S3 is at level L. That is, the transfer gate 334c outputs the drive signal COMC to the output terminal when the selection signal S3 is at level H, and does not output the drive signal COMC to the output terminal when the selection signal S3 is at level L.

The output terminals of the transfer gates 334a, 334b, and 334c are coupled in common. That is, the output terminals of the transfer gates 334a, 334b, and 334c coupled in common are supplied with the drive signals COMA, COMB, and COMC that are selected or not selected based on the selection signals S1, S2, and S3. The selection circuit 330 outputs the signal supplied to the output terminals coupled in common to the corresponding ejecting portion 600 as the drive signal VOUT.

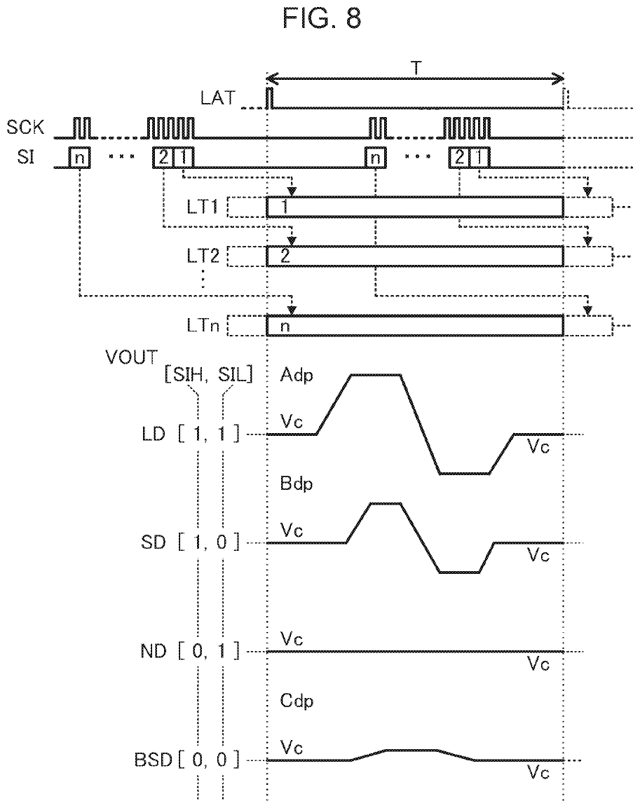

An operation of the drive signal selection circuit 300 will be described. FIG. 8 is a diagram showing an operation of the drive signal selection circuit 300. The print data signal SI is serially input in synchronization with the clock signal SCK, and is sequentially transmitted by the shift registers 312 corresponding to the ejecting portions 600. When the input of the clock signal SCK stops, the 2-bit print data [SIH, SIL] corresponding to each of the ejecting portions 600 is held in the corresponding shift registers 312.

Then, when the latch signal LAT rises, the 2-bit print data [SIH, SIL] held in the shift registers 312 are simultaneously latched by the latch circuits 314. FIG. 8 shows the 2-bit print data [SIH, SIL] latched by the latch circuits 314 and corresponding to the shift registers 312 of the first stage, the second stage, . . . , the n-th stage as LT1, LT2, . . . , LTn.

The decoder 316 outputs the selection signals S1, S2, and S3 having the logic levels defined by the latched 2-bit print data [SIH, SIL].

Specifically, when the print data [SIH, SIL] is [1, 1], the decoder 316 outputs the logic levels of the selection signals S1, S2, and S3 to the selection circuit 330 in the cycle T as levels H, L, and L, respectively. Accordingly, the selection circuit 330 selects the trapezoidal waveform Adp in the cycle T, and outputs the drive signal VOUT corresponding to “large dot LD”. When the print data [SIH, SIL] is [1, 0], the decoder 316 outputs the logic levels of the selection signals S1, S2, and S3 to the selection circuit 330 in the cycle T as levels L, H, and L, respectively. Accordingly, the selection circuit 330 selects the trapezoidal waveform Bdp in the cycle T, and outputs the drive signal VOUT corresponding to “small dot SD”. When the print data [SIH, SIL] is [0, 1], the decoder 316 outputs the logic levels of the selection signals S1, S2, and S3 to the selection circuit 330 in the cycle T as levels L, L, and L, respectively. Accordingly, the selection circuit 330 does not select any of the trapezoidal waveforms Adp, Bdp, and Cdp in the cycle T, and outputs the drive signal VOUT corresponding to “no ejection ND” that is constant at the voltage Vc. When the print data [SIH, SIL] is [0, 0], the decoder 316 outputs the logic levels of the selection signals S1, S2, and S3 to the selection circuit 330 in the cycle T as levels L, L, and H, respectively. Accordingly, the selection circuit 330 selects the trapezoidal waveform Cdp in the cycle T, and outputs the drive signal VOUT corresponding to “microvibration BSD”.

When the selection circuit 330 does not select any of the trapezoidal waveforms Adp, Bdp, and Cdp, the voltage Vc supplied to the piezoelectric element 60 immediately previously is held at one end of the corresponding piezoelectric element 60 by a capacitive component of the piezoelectric element 60. That is, the output of the drive signal VOUT that is constant at the voltage Vc by the selection circuit 330 includes the supply of the immediately previous voltage Vc held by the capacitive component of the piezoelectric element 60 to the piezoelectric element 60 as the drive signal VOUT, when none of the trapezoidal waveforms Adp, Bdp, and Cdp is selected as the drive signal VOUT.

As described above, the drive signal selection circuit 300 generates the drive signal VOUT corresponding to each of the plurality of ejecting portions 600 by selecting or not selecting the drive signals COMA, COMB, and COMC based on the print data signal SI, the latch signal LAT, and the clock signal SCK, and outputs the drive signal VOUT to the corresponding ejecting portion 600. Accordingly, the amount of the ink ejected from each of the plurality of ejecting portions 600 is individually controlled.

That is, the drive signals COMA, COMB, and COMC include the trapezoidal waveforms Adp, Bdp, and Cdp for each cycle T defined by the latch signal LAT. The drive signal selection circuit 300 generates n drive signals VOUT corresponding to the n ejecting portions 600 by selecting one of the trapezoidal waveforms Adp, Bdp, and Cdp or not selecting any thereof for each cycle T defined by the latch signal LAT, and outputs the n drive signals VOUT to the corresponding ejecting portions 600. In other words, the driving of the ejecting module 32 is controlled to form dots having a desired size on the medium P for each cycle T defined by the latch signal LAT, and the drive signal output circuit 50 is controlled to output the drive signals COMA, COMB, and COMC for each cycle T defined by the latch signal LAT. The latch signal LAT is defined by the timing signal PTS corresponding to the encoder signal ENC based on the transport position of the medium P. That is, the timing signal PTS is a signal for defining an ejection timing of the ink from the ejecting module 32, and a timing at which the drive signal output circuit 50 outputs the drive signals COMA, COMB, and COMC, which are timings of operation of the liquid ejecting apparatus 1.

### 3. Waveform Selection of Drive Signal

As described above, in the liquid ejecting apparatus 1 of the present embodiment, the plurality of head units 5 operate in synchronization via the timing signal PTS. Accordingly, the ejection timings of the ink from each of the plurality of head units 5 synchronize to form a desired image on the medium P.

However, during a period in which the transport unit 4 does not transport the medium P, which is a period in which the liquid ejecting apparatus 1 does not form an image on the medium P, the encoder signal ENC is not output, and thus the timing signal PTS is not output. In the liquid ejecting apparatus 1 of the related art, a configuration corresponding to the control unit 2 outputs a pseudo-timing signal for defining an operation timing to a configuration corresponding to the plurality of head units 5, and outputs a signal for controlling an operation of the configuration corresponding to the plurality of head units 5 at a timing synchronized with the pseudo-timing signal. Accordingly, the operation of the plurality of head units 5 during a period in which the timing signal PTS corresponding to the encoder signal ENC is not input is controlled. Thus, in the liquid ejecting apparatus 1 of the related art, an issue arises in that a processing load in the configuration corresponding to the control unit 2 increases.

In addition, the operation of the configuration corresponding to the plurality of head units 5 is controlled by the configuration corresponding to the control unit 2. Thus, when the head unit 5 that is attachable and interchangeable with respect to the liquid ejecting apparatus 1 and the control unit 2 as shown in the present embodiment is used, control specifications of the control unit 2 need to be changed in accordance with specifications of the used head unit 5. Thus, in the liquid ejecting apparatus 1 of the related art, an issue also arises in that versatility of the control unit 2 and the head unit 5 is likely to decrease.

In view of such an issue, during a period in which the medium P is not transported, which is a period in which the liquid ejecting apparatus 1 does not form an image on the medium P, the liquid ejecting apparatus 1 of the present embodiment reduces the processing load of the control unit 2 by synchronizing each of the plurality of head units 5 with an internally generated signal for defining an operation timing, and individually executing a sequence control via each of the plurality of head units 5. During a period in which the medium P is transported, which is a period in which the liquid ejecting apparatus 1 forms an image on the medium P, the plurality of head units 5 operate in synchronization with the timing signal PTS corresponding to the encoder signal ENC. Accordingly, an effect of being able to form a desired image on the medium P by synchronizing the ejection timings of the ink from each of the plurality of head units 5 during a period in which the liquid ejecting apparatus 1 forms an image on the medium P, and being able to reduce the processing load of the control unit 2 during a period in which the liquid ejecting apparatus 1 does not form an image on the medium P is achieved.

Furthermore, in the liquid ejecting apparatus 1 of the present embodiment, mode switching between the operation mode in which each of the plurality of head units 5 individually executes the sequence control in synchronization with the internally generated signal for defining the operation timing, and the operation mode in which each of the plurality of head units 5 operates in synchronization with the timing signal PTS corresponding to the encoder signal ENC is executed based on the timing signal PTS corresponding to the encoder signal ENC. Accordingly, even when each of the plurality of head units 5 has the operation mode in which each of the plurality of head units 5 individually executes the sequence control in synchronization with the internally generated signal for defining the operation timing, the control specifications of the control unit 2 do not need to be changed, and the versatility of the control unit 2 and the head unit 5 is less likely to decrease.

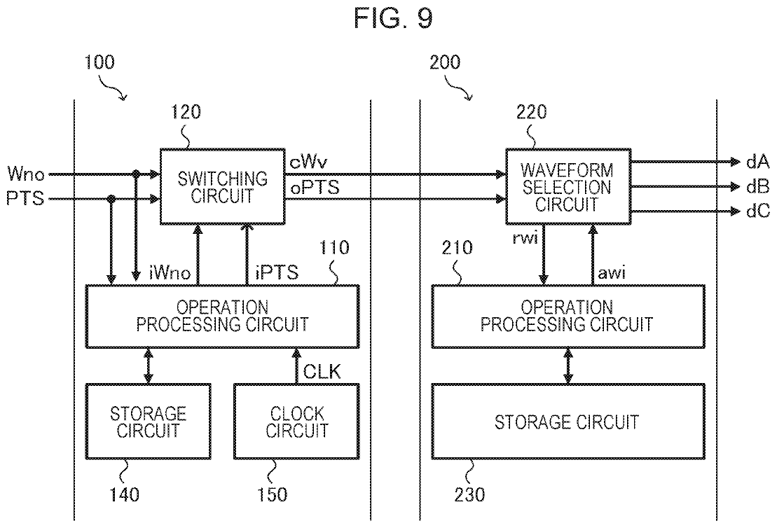

A specific example of such a configuration and an example of its operation will be described. FIG. 9 is a diagram showing an example of the configuration in which the head unit 5 has the operation mode in which the head unit 5 individually executes the sequence control, and the operation mode in which the head unit 5 operates in synchronization with the timing signal PTS. As shown in FIG. 9, such a configuration includes an operation processing circuit 110, a switching circuit 120, a storage circuit 140, and a clock circuit 150 included in the control circuit 100, and an operation processing circuit 210, a waveform selection circuit 220, and a storage circuit 230 included in the control circuit 200.

The operation processing circuit 110 receives input of the drive control signal Wno including waveform selection information wn, which will be described later, and the timing signal PTS. The operation processing circuit 110 reads waveform selection information iwn, which will be described later, from the storage circuit 140 in accordance with the drive control signal Wno and the timing signal PTS. The operation processing circuit 110 generates an internal drive control signal iWno including the read waveform selection information iwn, and outputs the internal drive control signal iWno. The operation processing circuit 110 also generates an internal timing signal iPTS based on a clock signal CLK generated by the clock circuit 150, and outputs the internal timing signal iPTS.

The switching circuit 120 receives input of the drive control signal Wno including the waveform selection information wn, the timing signal PTS, the internal drive control signal iWno including the waveform selection information iwn, and the internal timing signal iPTS. The switching circuit 120 switches between selecting the waveform selection information wn and selecting the waveform selection information iwn by switching between selecting the drive control signal Wno and selecting the internal drive control signal iWno. The switching circuit 120 generates the waveform selection signal cWv including waveform selection information cwv corresponding to the selected waveform selection information wn or waveform selection information iwn, and outputs the waveform selection signal cWv. The switching circuit 120 switches between selecting the timing signal PTS and selecting the internal timing signal iPTS. The switching circuit 120 generates a timing signal oPTS corresponding to the selected timing signal PTS or internal timing signal iPTS, and outputs the timing signal oPTS.

The waveform selection circuit 220 receives input of the waveform selection signal cWv including the waveform selection information cwv, and the timing signal oPTS. At a timing defined by the timing signal oPTS, the waveform selection circuit 220 acquires the waveform selection information cwv included in the waveform selection signal cWv, and outputs the waveform selection information cwv to the operation processing circuit 210 as a waveform designation signal rwi. The operation processing circuit 210 reads waveform information wi corresponding to the waveform selection information cwv from the storage circuit 230 in accordance with the input waveform designation signal rwi. The operation processing circuit 210 generates a waveform information signal awi including the read waveform information wi, and outputs the waveform information signal awi to the waveform selection circuit 220.

The waveform selection circuit 220 generates the base drive signals dA, dB, and dC corresponding to the waveform information wi included in the input waveform information signal awi, and outputs the base drive signals dA, dB, and dC. The drive signal output circuit 50 receives input of the base drive signals dA, dB, and dC output by the waveform selection circuit 220. Accordingly, the drive signal output circuit 50 outputs the drive signals COMA, COMB, and COMC having signal waveforms defined by the waveform information wi.

A specific example of an operation of the above configuration in which the head unit 5 has the operation mode in which the head unit 5 individually executes the sequence control, and the operation mode in which the head unit 5 operates in synchronization with the timing signal PTS will be described. The liquid ejecting apparatus 1 of the present embodiment described here has a boot mode, a sleep mode, a standby mode, a start-up mode, an end-down mode, a forced microvibration mode, and an ejection mode as operation modes. The ejection mode described here includes a normal ejection mode, a high-speed ejection mode, and a high-definition ejection mode.

The boot mode is a mode for starting the operation of the liquid ejecting apparatus 1. The sleep mode is an operation mode in which the ink is not ejected to the medium P, and power consumption of the liquid ejecting apparatus 1 is reduced by setting the voltage values of the drive signals COMA, COMB, and COMC to be constant at a voltage Vos lower than the voltage Vc. The standby mode is an operation mode in which the ink is not ejected to the medium P, and the ink can be ejected to the medium P in a short time by setting the voltage values of the drive signals COMA, COMB, and COMC to be constant at the voltage Vc. The start-up mode is an operation mode in transitioning from the sleep mode to the standby mode. The end-down mode is an operation mode in transitioning from the standby mode to the sleep mode. The forced microvibration mode is an operation mode in which the plurality of ejecting portions 600 included in the ejecting module 32 are forced to execute microvibration. The ejection mode is an operation mode in which the ink can be ejected to the medium P. The normal ejection mode included in the ejection mode is an operation mode in which an image having normal image quality is formed on the medium P. The high-speed ejection mode included in the ejection mode is an operation mode in which an image is formed on the medium P at a higher speed than the normal ejection mode. The high-definition ejection mode included in the ejection mode is an operation mode in which an image having higher definition than the normal ejection mode is formed on the medium P.

The operation modes of the liquid ejecting apparatus 1 are not limited to the above and may include, for example, an inspection mode in which states of the ejecting module 32 and the ejecting portion 600 included in the ejecting module 32 are inspected, and a maintenance mode in which maintenance processing is executed on the ejecting portion 600 included in the ejecting module 32.

In describing an example of the operation of the configuration in which the head unit 5 has the operation mode in which the head unit 5 individually executes the sequence control, and the operation mode in which the head unit 5 operates in synchronization with the timing signal PTS, first, an example of the waveform selection information wn included in the drive control signal Wno, an example of the waveform selection information iwn included in the internal drive control signal iWno, and an example of a relationship between the waveform selection information cwv and the waveform information wi stored in the storage circuit 230 will be described.

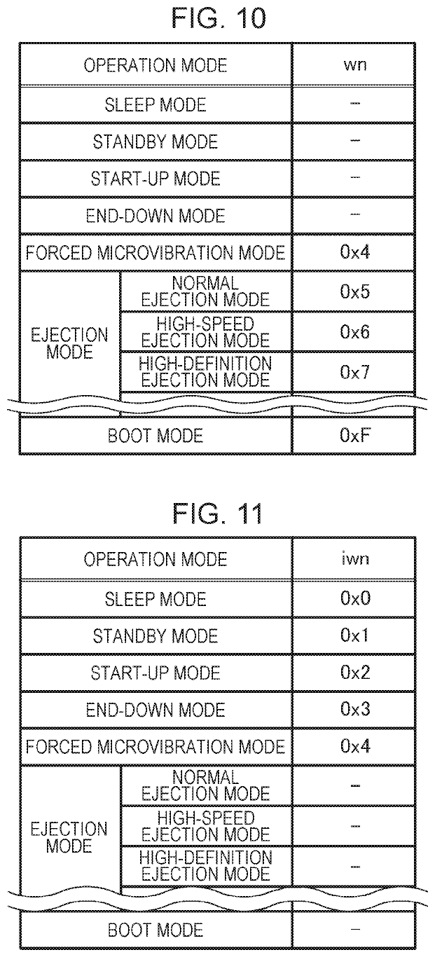

FIG. 10 is a diagram showing an example of a data configuration of the drive control signal Wno. The drive control signal Wno includes 4-bit waveform selection information wn for defining the signal waveforms of the drive signals COMA, COMB, and COMC in accordance with the operation mode of the liquid ejecting apparatus 1.

As shown in FIG. 10, when the operation mode of the liquid ejecting apparatus 1 is the boot mode, the control unit 2 outputs the drive control signal Wno including the waveform selection information wn=[0xF]. When the operation mode of the liquid ejecting apparatus 1 is the forced microvibration mode, the control unit 2 outputs the drive control signal Wno including the waveform selection information wn=[0x4]. When the operation mode of the liquid ejecting apparatus 1 is the normal ejection mode, the control unit 2 outputs the drive control signal Wno including the waveform selection information wn=[0x5]. When the operation mode of the liquid ejecting apparatus 1 is the high-speed ejection mode, the control unit 2 outputs the drive control signal Wno including the waveform selection information wn=[0x6]. When the operation mode of the liquid ejecting apparatus 1 is the high-definition ejection mode, the control unit 2 outputs the drive control signal Wno including the waveform selection information wn=[0x7].

While the example of the data configuration of the drive control signal Wno shown in FIG. 10 shows not assigning the waveform selection information wn corresponding to each of the sleep mode, the standby mode, the start-up mode, and the end-down mode, the waveform selection information wn corresponding to each of the sleep mode, the standby mode, the start-up mode, and the end-down mode may be assigned. While the example in FIG. 10 shows the 4-bit waveform selection information wn included in the drive control signal Wno, the waveform selection information wn is not limited to 4 bits and may be 5 bits or more or 3 bits or less.

FIG. 11 is a diagram showing an example of a data configuration of the internal drive control signal iWno. The internal drive control signal iWno includes 4-bit waveform selection information iwn for defining the signal waveforms of the drive signals COMA, COMB, and COMC in accordance with the operation mode of the liquid ejecting apparatus 1.

As shown in FIG. 11, when the operation mode of the liquid ejecting apparatus 1 is the sleep mode, the operation processing circuit 110 outputs the internal drive control signal iWno including the waveform selection information iwn=[0x0]. When the operation mode of the liquid ejecting apparatus 1 is the standby mode, the operation processing circuit 110 outputs the internal drive control signal iWno including the waveform selection information iwn=[0x1]. When the operation mode of the liquid ejecting apparatus 1 is the start-up mode, the operation processing circuit 110 outputs the internal drive control signal iWno including the waveform selection information iwn=[0x2]. When the operation mode of the liquid ejecting apparatus 1 is the end-down mode, the operation processing circuit 110 outputs the internal drive control signal iWno including the waveform selection information iwn=[0x3]. When the operation mode of the liquid ejecting apparatus 1 is the forced microvibration mode, the operation processing circuit 110 outputs the internal drive control signal iWno including the waveform selection information iwn=[0x4].

The waveform selection information iwn included in the internal drive control signal iWno is not limited to 4-bit information and only needs to have the same number of bits as the waveform selection information wn included in the drive control signal Wno. The same information is assigned to the waveform selection information wn and the waveform selection information iwn corresponding to the same operation mode of the liquid ejecting apparatus 1.

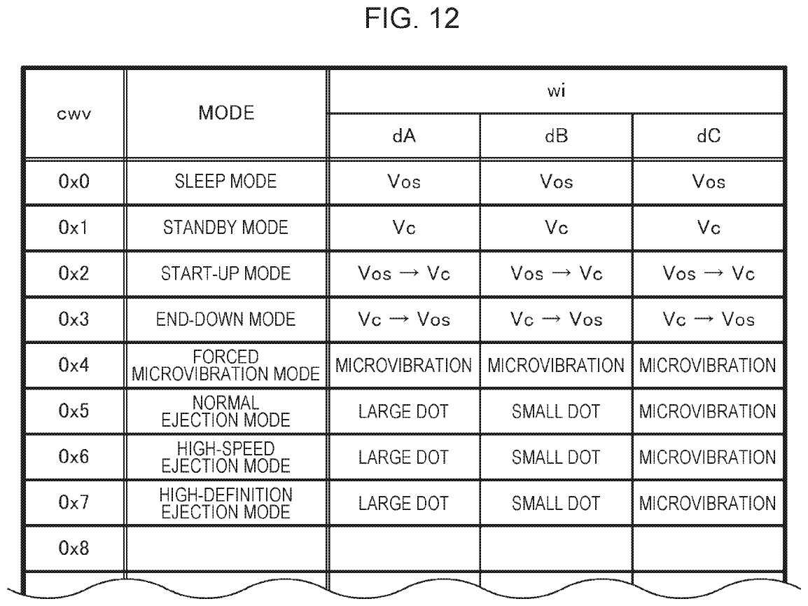

FIG. 12 is a diagram showing an example of the relationship between the waveform selection information cwv and the waveform information wi stored in the storage circuit 230. As described above, the storage circuit 230 stores the waveform information wi corresponding to the waveform selection information cwv.

Specifically, as shown in FIG. 12, the storage circuit 230 stores, as the waveform information wi corresponding to the waveform selection information cwv, information for defining the signal waveform of the drive signal COMA, information for defining the signal waveform of the drive signal COMB, and information for defining the signal waveform of the drive signal COMC.

For example, the example shown in FIG. 12 shows the storage circuit 230 storing, as the waveform information wi corresponding to the waveform selection information cwv=[0x0], information for defining the signal waveform of the drive signal COMA having a constant voltage value at the voltage Vos, information for defining the signal waveform of the drive signal COMB having a constant voltage value at the voltage Vos, and information for defining the signal waveform of the drive signal COMC having a constant voltage value at the voltage Vos.

In addition, for example, the example shown in FIG. 12 shows the storage circuit 230 storing, as the waveform information wi corresponding to the waveform selection information cwv=[0x3], information for defining the signal waveform of the drive signal COMA having a voltage value that changes from the voltage Vc to the voltage Vos, information for defining the signal waveform of the drive signal COMB having a voltage value that changes from the voltage Vc to the voltage Vos, and information for defining the signal waveform of the drive signal COMC having a voltage value that changes from the voltage Vc to the voltage Vos.

In addition, for example, the example shown in FIG. 12 shows the storage circuit 230 storing, as the waveform information wi corresponding to the waveform selection information cwv=[0x5], information for defining the signal waveform of the drive signal COMA having a voltage value that changes to eject the ink corresponding to the large dot LD from the ejecting portion 600, information for defining the signal waveform of the drive signal COMB having a voltage value that changes to eject the ink corresponding to the small dot SD from the ejecting portion 600, and information for defining the signal waveform of the drive signal COMC having a voltage value that changes to cause the ejecting portion 600 to execute microvibration, when the liquid ejecting apparatus 1 operates in the normal ejection mode.

As described above, in the configuration in which the head unit 5 in the liquid ejecting apparatus 1 of the present embodiment has the operation mode in which the head unit 5 individually executes the sequence control, and the operation mode in which the head unit 5 operates in synchronization with the timing signal PTS, the drive control signal Wno includes the waveform selection information wn as shown in FIG. 10, the internal drive control signal iWno includes the waveform selection information iwn as shown in FIG. 11, and the storage circuit 230 stores the waveform information wi corresponding to the waveform selection information cwv as shown in FIG. 12.

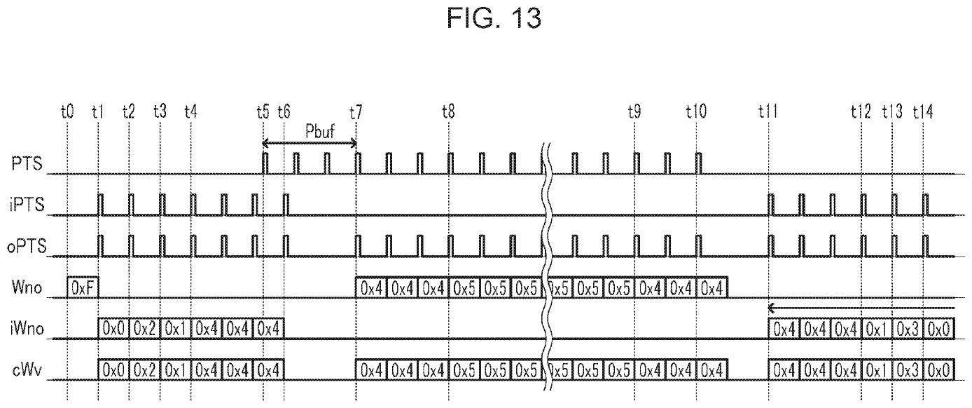

FIG. 13 is a diagram showing an example of the operation of the configuration in which the head unit 5 has the operation mode in which the head unit 5 individually executes the sequence control, and the operation mode in which the head unit 5 operates in synchronization with the timing signal PTS.

As shown in FIG. 13, at time t0 when the liquid ejecting apparatus 1 starts operating, the control unit 2 outputs the drive control signal Wno including the waveform selection information wn=[0xF] corresponding to the boot mode. Here, the transport of the medium P by the control unit 2 is not started. Accordingly, at time t0, the control unit 2 does not output the timing signal PTS corresponding to the encoder signal ENC.

At time t0, the operation processing circuit 110 and the switching circuit 120 receive input of the drive control signal Wno including the waveform selection information wn=[0xF] output by the control unit 2. When the operation processing circuit 110 does not receive input of the timing signal PTS corresponding to the encoder signal ENC and receives input of the drive control signal Wno including the waveform selection information wn=[0xF] corresponding to the boot mode, the operation processing circuit 110 starts a predetermined sequence control at subsequent time t1.

At time t1, when the operation processing circuit 110 starts the predetermined sequence control, the operation processing circuit 110 reads the waveform selection information iwn=[0x0] corresponding to the sleep mode from the storage circuit 140, and outputs the internal drive control signal iWno including the read waveform selection information iwn=[0x0] to the switching circuit 120. In addition, at time t1, the operation processing circuit 110 generates the internal timing signal iPTS based on the clock signal CLK generated by the clock circuit 150, and outputs the internal timing signal iPTS to the switching circuit 120.

At time t1, when the timing signal PTS corresponding to the encoder signal ENC is not input into the switching circuit 120, the switching circuit 120 selects the internal drive control signal iWno as the waveform selection signal cWv and selects the internal timing signal iPTS as the timing signal oPTS. Accordingly, at time t1, the waveform selection circuit 220 receives input of the waveform selection signal cWv including the waveform selection information cwv=[0x0] and the timing signal oPTS corresponding to the internal timing signal iPTS. The waveform selection circuit 220 reads, from the storage circuit 230, information for defining the signal waveform of the drive signal COMA having a constant voltage value at the voltage Vos, information for defining the signal waveform of the drive signal COMB having a constant voltage value at the voltage Vos, and information for defining the signal waveform of the drive signal COMC having a constant voltage value at the voltage Vos, as the waveform information wi corresponding to the input waveform selection information cwv=[0x0]. Accordingly, at time t1, the waveform selection circuit 220 outputs the base drive signals dA, dB, and dC for defining the signal waveforms of the drive signals COMA, COMB, and COMC having constant voltage values at the voltage Vos. Accordingly, at time t1, the drive signal output circuit 50 outputs the drive signals COMA, COMB, and COMC having constant voltage values at the voltage Vos in the cycle defined by the internal timing signal iPTS. That is, the operation mode of the liquid ejecting apparatus 1 changes to the sleep mode.

At subsequent time t2, the operation processing circuit 110 reads the waveform selection information iwn=[0x2] corresponding to the start-up mode from the storage circuit 140, and outputs the internal drive control signal iWno including the read waveform selection information iwn=[0x2] to the switching circuit 120 by executing the predetermined sequence control in synchronization with the internal timing signal iPTS.

In addition, at time t2, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t2, the waveform selection circuit 220 receives input of the waveform selection signal cWv including the waveform selection information cwv=[0x2] and the timing signal oPTS corresponding to the internal timing signal iPTS. The waveform selection circuit 220 reads, from the storage circuit 230, information for defining the signal waveform of the drive signal COMA having a voltage value that changes from the voltage Vos to the voltage Vc, information for defining the signal waveform of the drive signal COMB having a voltage value that changes from the voltage Vos to the voltage Vc, and information for defining the signal waveform of the drive signal COMC having a voltage value that changes from the voltage Vos to the voltage Vc, as the waveform information wi corresponding to the input waveform selection information cwv=[0x2]. Accordingly, at time t2, the waveform selection circuit 220 outputs the base drive signals dA, dB, and dC for defining the signal waveforms of the drive signals COMA, COMB, and COMC having voltage values that change from the voltage Vos to the voltage Vc. Accordingly, at time t2, the drive signal output circuit 50 outputs the drive signals COMA, COMB, and COMC having voltage values that change from the voltage Vos to the voltage Vc, in the cycle defined by the internal timing signal iPTS. That is, the operation mode of the liquid ejecting apparatus 1 changes to the start-up mode.

As described above, in the liquid ejecting apparatus 1 of the present embodiment, at time t0 when the drive control signal Wno including the waveform selection information wn=[0xF] for the ejecting module 32 included in the liquid ejecting apparatus 1 to start operating, which is a signal for the liquid ejecting apparatus 1 to start scanning, is input from the control unit 2, the control circuits 100 and 200 control the drive signal output circuit 50 to output the drive signals COMA, COMB, and COMC having voltage values that change from the voltage Vos to the voltage Vc, in the cycle defined by the internal timing signal iPTS.

At subsequent time t3, the operation processing circuit 110 reads the waveform selection information iwn=[0x1] corresponding to the standby mode from the storage circuit 140, and outputs the internal drive control signal iWno including the read waveform selection information iwn=[0x1] to the switching circuit 120 by executing the predetermined sequence control in synchronization with the internal timing signal iPTS.

In addition, at time t3, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t3, the waveform selection circuit 220 receives input of the waveform selection signal cWv including the waveform selection information cwv=[0x1] and the timing signal oPTS corresponding to the internal timing signal iPTS. The waveform selection circuit 220 reads, from the storage circuit 230, information for defining the signal waveform of the drive signal COMA having a constant voltage value at the voltage Vc, information for defining the signal waveform of the drive signal COMB having a constant voltage value at the voltage Vc, and information for defining the signal waveform of the drive signal COMC having a constant voltage value at the voltage Vc, as the waveform information wi corresponding to the input waveform selection information cwv=[0x1]. Accordingly, the waveform selection circuit 220 outputs the base drive signals dA, dB, and dC for defining the signal waveforms of the drive signals COMA, COMB, and COMC having constant voltage values at the voltage Vc. Accordingly, at time t3, the drive signal output circuit 50 outputs the drive signals COMA, COMB, and COMC having constant voltage values at the voltage Vc in the cycle defined by the internal timing signal iPTS. That is, the operation mode of the liquid ejecting apparatus 1 changes to the standby mode.

At subsequent time t4, the operation processing circuit 110 reads the waveform selection information iwn=[0x4] corresponding to the forced microvibration mode from the storage circuit 140, and outputs the internal drive control signal iWno including the read waveform selection information iwn=[0x4] to the switching circuit 120 by executing the predetermined sequence control in synchronization with the internal timing signal iPTS.

In addition, at time t4, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t4, the waveform selection circuit 220 receives input of the waveform selection signal cWv including the waveform selection information cwv=[0x4] and the timing signal oPTS corresponding to the internal timing signal iPTS. The waveform selection circuit 220 reads, from the storage circuit 230, information for defining the signal waveform of the drive signal COMA for causing the ejecting portion 600 to execute microvibration, information for defining the signal waveform of the drive signal COMB for causing the ejecting portion 600 to execute microvibration, and information for defining the signal waveform of the drive signal COMC for causing the ejecting portion 600 to execute microvibration, as the waveform information wi corresponding to the input waveform selection information cwv=[0x4]. Accordingly, the waveform selection circuit 220 outputs the base drive signals dA, dB, and dC for defining the signal waveforms of the drive signals COMA, COMB, and COMC for causing the ejecting portion 600 to execute microvibration. Accordingly, at time t4, the drive signal output circuit 50 outputs the drive signals COMA, COMB, and COMC corresponding to microvibration in the cycle defined by the internal timing signal iPTS. That is, the operation mode of the liquid ejecting apparatus 1 changes to the forced microvibration mode. Then, the liquid ejecting apparatus 1 continues the forced microvibration mode via the predetermined sequence control executed by the operation processing circuit 110 during a period before the timing signal PTS corresponding to the encoder signal ENC is input.

As described above, in the liquid ejecting apparatus 1 of the present embodiment, after time t0, the control circuits 100 and 200, at time t3 when the voltage value of the drive signal COM reaches the voltage Vc, control the drive signal output circuit 50 to output the drive signals COMA, COMB, and COMC including microvibration waveforms, such as the trapezoidal waveform Cdp, for driving the piezoelectric element 60 not to eject the ink from the ejecting module 32, in the cycle defined by the internal timing signal iPTS.

After the operation mode of the liquid ejecting apparatus 1 transitions to the forced microvibration mode, the control unit 2 starts transporting the medium P at time t5 after a predetermined period elapses. Accordingly, at time t5, the operation processing circuit 110 and the switching circuit 120 receive input of the timing signal PTS corresponding to the encoder signal ENC.

At time t6 after time t5, the operation processing circuit 110 finishes the execution of the predetermined sequence control. Accordingly, at time t6, the operation processing circuit 110 stops outputting the internal drive control signal iWno including the waveform selection information iwn=[0x4], and the internal timing signal iPTS.

At time t6, when the switching circuit 120 starts receiving input of the timing signal PTS corresponding to the encoder signal ENC, the switching circuit 120 selects the drive control signal Wno as the waveform selection signal cWv and selects the timing signal PTS as the timing signal oPTS. Here, the control unit 2 does not output the drive control signal Wno including predetermined waveform selection information wn. Accordingly, at time t6, the waveform selection circuit 220 stops receiving input of the waveform selection signal cWv including predetermined waveform selection information cwv. Thus, the drive signal output circuit 50 stops outputting the drive signals COMA, COMB, and COMC corresponding to microvibration.

At time t6, the drive signal output circuit 50 stops outputting the drive signals COMA, COMB, and COMC corresponding to microvibration. Then, at time t7 after a predetermined period elapses, the control unit 2 outputs the drive control signal Wno including the waveform selection information wn=[0x4] corresponding to the forced microvibration mode in synchronization with the timing signal PTS.

At time t7, the timing signal PTS corresponding to the encoder signal ENC is input into the switching circuit 120. Thus, the switching circuit 120 selects the drive control signal Wno as the waveform selection signal cWv and selects the timing signal PTS as the timing signal oPTS. Therefore, at time t7, the waveform selection circuit 220 receives input of the waveform selection signal cWv including the waveform selection information cwv=[0x4] and the timing signal oPTS corresponding to the timing signal PTS. The waveform selection circuit 220 reads, from the storage circuit 230, information for defining the signal waveform of the drive signal COMA for causing the ejecting portion 600 to execute microvibration, information for defining the signal waveform of the drive signal COMB for causing the ejecting portion 600 to execute microvibration, and information for defining the signal waveform of the drive signal COMC for causing the ejecting portion 600 to execute microvibration, as the waveform information wi corresponding to the input waveform selection information cwv=[0x4]. Accordingly, the waveform selection circuit 220 outputs the base drive signals dA, dB, and dC for defining the signal waveforms of the drive signals COMA, COMB, and COMC for causing the ejecting portion 600 to execute microvibration. Accordingly, at time t7, the drive signal output circuit 50 outputs the drive signals COMA, COMB, and COMC corresponding to microvibration in the cycle defined by the timing signal PTS. That is, the forced microvibration mode starts again as the operation mode of the liquid ejecting apparatus 1.

As described above, in the liquid ejecting apparatus 1 of the present embodiment, at time t5 when the input of the timing signal PTS starts after time t3, the control circuits 100 and 200 control the drive signal output circuit 50 to output the drive signals COMA, COMB, and COMC including microvibration waveforms, such as the trapezoidal waveform Cdp, for driving the piezoelectric element 60 not to eject the ink from the ejecting module 32, in the cycle defined by the timing signal PTS.

After the drive signal output circuit 50 starts outputting the drive signals COMA, COMB, and COMC including the microvibration waveforms in the cycle defined by the timing signal PTS, the control unit 2, at time t8 after a predetermined period elapses, outputs the drive control signal Wno including the waveform selection information wn=[0x5] corresponding to the normal ejection mode in synchronization with the timing signal PTS in order to start ejecting the ink to the medium P.

At time t8, the timing signal PTS corresponding to the encoder signal ENC is input into the switching circuit 120. Thus, the switching circuit 120 selects the drive control signal Wno as the waveform selection signal cWv and selects the timing signal PTS as the timing signal oPTS. Therefore, at time t8, the waveform selection circuit 220 receives input of the waveform selection signal cWv including the waveform selection information cwv=[0x5] and the timing signal oPTS corresponding to the timing signal PTS. The waveform selection circuit 220 reads, from the storage circuit 230, as the waveform information wi corresponding to the input waveform selection information cwv=[0x5], information for defining the signal waveform of the drive signal COMA having a voltage value that changes to eject the ink corresponding to the large dot LD from the ejecting portion 600, information for defining the signal waveform of the drive signal COMB having a voltage value that changes to eject the ink corresponding to the small dot SD from the ejecting portion 600, and information for defining the signal waveform of the drive signal COMC having a voltage value that changes to cause the ejecting portion 600 to execute microvibration, when the operation mode of the liquid ejecting apparatus 1 is the normal ejection mode. Accordingly, the waveform selection circuit 220 outputs the base drive signals dA, dB, and dC for defining the signal waveforms of the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration. Accordingly, at time t8, the drive signal output circuit 50 outputs the drive signal COMA having a voltage value that changes to eject the ink corresponding to the large dot LD from the ejecting portion 600, the drive signal COMB having a voltage value that changes to eject the ink corresponding to the small dot SD from the ejecting portion 600, and the drive signal COMC having a voltage value that changes to cause the ejecting portion 600 to execute microvibration, in the cycle defined by the timing signal PTS. That is, the operation mode of the liquid ejecting apparatus 1 changes to the normal ejection mode.

As described above, in the liquid ejecting apparatus 1 of the present embodiment, at time t8 after a predetermined period elapses from time t5, the control circuits 100 and 200 control the drive signal output circuit 50 to output the drive signals COMA and COMB including the trapezoidal waveforms Adp and Bdp for driving the piezoelectric element 60 to eject the ink from the ejecting module 32, in the cycle defined by the timing signal PTS.

As shown in FIG. 13, a buffer period Pbuff in which the control circuits 100 and 200 control the drive signal output circuit 50 to stop outputting the drive signals COMA, COMB, and COMC corresponding to microvibration in the cycle defined by the internal timing signal iPTS is included between time t5 and time t8 after a predetermined period elapses. At time t7 after the buffer period Pbuff elapses, the control circuits 100 and 200 control the drive signal output circuit 50 to stop outputting the drive signals COMA, COMB, and COMC corresponding to microvibration in the cycle defined by the timing signal PTS. Accordingly, various signals are less likely to interfere between an operation in the cycle defined by the internal timing signal iPTS and an operation in the cycle defined by the timing signal PTS.

At time t9 when the ejection of the ink to the medium P in the normal ejection mode is completed, the control unit 2 outputs the drive control signal Wno including the waveform selection information wn=[0x4] corresponding to the forced microvibration mode in synchronization with the timing signal PTS.

At time t9, the timing signal PTS corresponding to the encoder signal ENC is input into the switching circuit 120. Thus, the switching circuit 120 selects the drive control signal Wno as the waveform selection signal cWv and selects the timing signal PTS as the timing signal oPTS. Therefore, at time t9, the waveform selection circuit 220 receives input of the waveform selection signal cWv including the waveform selection information cwv=[0x4] and the timing signal oPTS corresponding to the timing signal PTS. The waveform selection circuit 220 reads, from the storage circuit 230, information for defining the signal waveform of the drive signal COMA for causing the ejecting portion 600 to execute microvibration, information for defining the signal waveform of the drive signal COMB for causing the ejecting portion 600 to execute microvibration, and information for defining the signal waveform of the drive signal COMC for causing the ejecting portion 600 to execute microvibration, as the waveform information wi corresponding to the input waveform selection information cwv=[0x4]. Accordingly, the waveform selection circuit 220 outputs the base drive signals dA, dB, and dC for defining the signal waveforms of the drive signals COMA, COMB, and COMC for causing the ejecting portion 600 to execute microvibration. Accordingly, at time t9, the drive signal output circuit 50 outputs the drive signals COMA, COMB, and COMC corresponding to microvibration in the cycle defined by the timing signal PTS. That is, the operation mode of the liquid ejecting apparatus 1 changes to the forced microvibration mode.

Then, at time t10, the control unit 2 stops transporting the medium P. Accordingly, at time t10, the input of the timing signal PTS corresponding to the encoder signal ENC into the operation processing circuit 110 and the switching circuit 120 stops. At time t11 after a predetermined period elapses from time t10, the operation processing circuit 110 starts the predetermined sequence control.

At time t11, when the operation processing circuit 110 starts the predetermined sequence control, the operation processing circuit 110 reads the waveform selection information iwn=[0x4] corresponding to the forced microvibration mode from the storage circuit 140, and outputs the internal drive control signal iWno including the read waveform selection information iwn=[0x4] to the switching circuit 120. In addition, at time t11, the operation processing circuit 110 generates the internal timing signal iPTS based on the clock signal CLK generated by the clock circuit 150, and outputs the internal timing signal iPTS to the switching circuit 120.

In addition, at time t11, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t11, the waveform selection circuit 220 receives input of the waveform selection signal cWv including the waveform selection information cwv=[0x4] and the timing signal oPTS corresponding to the internal timing signal iPTS. The waveform selection circuit 220 reads, from the storage circuit 230, information for defining the signal waveform of the drive signal COMA for causing the ejecting portion 600 to execute microvibration, information for defining the signal waveform of the drive signal COMB for causing the ejecting portion 600 to execute microvibration, and information for defining the signal waveform of the drive signal COMC for causing the ejecting portion 600 to execute microvibration, as the waveform information wi corresponding to the input waveform selection information cwv=[0x4]. Accordingly, at time t11, the waveform selection circuit 220 outputs the base drive signals dA, dB, and dC for defining the signal waveforms of the drive signals COMA, COMB, and COMC for causing the ejecting portion 600 to execute microvibration. Accordingly, at time t11, the drive signal output circuit 50 outputs the drive signals COMA, COMB, and COMC corresponding to microvibration in the cycle defined by the internal timing signal iPTS. That is, the operation mode of the liquid ejecting apparatus 1 changes to the forced microvibration mode.

As described above, in the liquid ejecting apparatus 1 of the present embodiment, at time t11 when the timing signal PTS corresponding to the encoder signal ENC is not input for a predetermined period after time t8, the control circuits 100 and 200 control the drive signal output circuit 50 to output the drive signals COMA, COMB, and COMC including microvibration waveforms, such as the trapezoidal waveform Cdp, for driving the piezoelectric element 60 not to eject the ink from the ejecting module 32, in the cycle defined by the internal timing signal iPTS.

After the operation mode of the liquid ejecting apparatus 1 transitions to the forced microvibration mode, the operation processing circuit 110, at time t12 after a predetermined period elapses, reads the waveform selection information iwn=[0x1] corresponding to the standby mode from the storage circuit 140, and outputs the internal drive control signal iWno including the read waveform selection information iwn=[0x1] to the switching circuit 120 by executing the predetermined sequence control in synchronization with the internal timing signal iPTS.

In addition, at time t12, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t12, the waveform selection circuit 220 receives input of the waveform selection signal cWv including the waveform selection information cwv=[0x1] and the timing signal oPTS corresponding to the internal timing signal iPTS. The waveform selection circuit 220 reads, from the storage circuit 230, information for defining the signal waveform of the drive signal COMA having a constant voltage value at the voltage Vc, information for defining the signal waveform of the drive signal COMB having a constant voltage value at the voltage Vc, and information for defining the signal waveform of the drive signal COMC having a constant voltage value at the voltage Vc, as the waveform information wi corresponding to the input waveform selection information cwv=[0x1]. Accordingly, the waveform selection circuit 220 outputs the base drive signals dA, dB, and dC for defining the signal waveforms of the drive signals COMA, COMB, and COMC having constant voltage values at the voltage Vc. Accordingly, at time t12, the drive signal output circuit 50 outputs the drive signals COMA, COMB, and COMC having constant voltage values at the voltage Vc in the cycle defined by the internal timing signal iPTS. That is, the operation mode of the liquid ejecting apparatus 1 changes to the standby mode.

At time t13 after the operation mode of the liquid ejecting apparatus 1 transitions to the standby mode, the operation processing circuit 110 reads the waveform selection information iwn=[0x3] corresponding to the end-down mode from the storage circuit 140, and outputs the internal drive control signal iWno including the read waveform selection information iwn=[0x3] to the switching circuit 120 by executing the predetermined sequence control in synchronization with the internal timing signal iPTS.

In addition, at time t13, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t13, the waveform selection circuit 220 receives input of the waveform selection signal cWv including the waveform selection information cwv=[0x3] and the timing signal oPTS corresponding to the internal timing signal iPTS. The waveform selection circuit 220 reads, from the storage circuit 230, information for defining the signal waveform of the drive signal COMA having a voltage value that changes from the voltage Vc to the voltage Vos, information for defining the signal waveform of the drive signal COMB having a voltage value that changes from the voltage Vc to the voltage Vos, and information for defining the signal waveform of the drive signal COMC having a voltage value that changes from the voltage Vc to the voltage Vos, as the waveform information wi corresponding to the input waveform selection information cwv=[0x3]. Accordingly, the waveform selection circuit 220 outputs the base drive signals dA, dB, and dC for defining the signal waveforms of the drive signals COMA, COMB, and COMC having voltage values that change from the voltage Vc to the voltage Vos. Accordingly, at time t13, the drive signal output circuit 50 outputs the drive signals COMA, COMB, and COMC having voltage values that change from the voltage Vc to the voltage Vos, in the cycle defined by the internal timing signal iPTS. That is, the operation mode of the liquid ejecting apparatus 1 changes to the end-down mode.

As described above, in the liquid ejecting apparatus 1 of the present embodiment, at time t13 after a predetermined period elapses from time t11, the control circuits 100 and 200 control the drive signal output circuit 50 to output the drive signals COMA, COMB, and COMC having voltage values that change from the voltage Vc to the voltage Vos, in the cycle defined by the internal timing signal iPTS.

At time t14 after the voltage values of the drive signals COMA, COMB, and COMC reach the voltage Vos, the operation processing circuit 110 reads the waveform selection information iwn=[0x0] corresponding to the sleep mode from the storage circuit 140, and outputs the internal drive control signal iWno including the read waveform selection information iwn=[0x0] to the switching circuit 120 by executing the predetermined sequence control in synchronization with the internal timing signal iPTS.

In addition, at time t14, the timing signal PTS corresponding to the encoder signal ENC is not input into the switching circuit 120. Thus, the switching circuit 120 selects the internal drive control signal iWno as the waveform selection signal cWv and selects the internal timing signal iPTS as the timing signal oPTS. Accordingly, at time t14, the waveform selection circuit 220 receives input of the waveform selection signal cWv including the waveform selection information cwv=[0x0] and the timing signal oPTS corresponding to the internal timing signal iPTS. The waveform selection circuit 220 reads, from the storage circuit 230, information for defining the signal waveform of the drive signal COMA having a constant voltage value at the voltage Vos, information for defining the signal waveform of the drive signal COMB having a constant voltage value at the voltage Vos, and information for defining the signal waveform of the drive signal COMC having a constant voltage value at the voltage Vos, as the waveform information wi corresponding to the input waveform selection information cwv=[0x0]. Accordingly, the waveform selection circuit 220 outputs the base drive signals dA, dB, and dC for defining the signal waveforms of the drive signals COMA, COMB, and COMC having constant voltage values at the voltage Vos. Accordingly, at time t14, the drive signal output circuit 50 outputs the drive signals COMA, COMB, and COMC having constant voltage values at the voltage Vos. That is, the operation mode of the liquid ejecting apparatus 1 changes to the sleep mode.

Accordingly, the series of operations of the configuration in which the head unit 5 has the operation mode in which the head unit 5 individually executes the sequence control, and the operation mode in which the head unit 5 operates in synchronization with the timing signal PTS are finished.

As described above, in the liquid ejecting apparatus 1 and the head unit 5 of the present embodiment, the control circuits 100 and 200 have a mode in which the control circuits 100 and 200 control the ejecting module 32 and the drive signal output circuit 50 in the cycle defined by the timing signal PTS corresponding to the encoder signal ENC, as in a period from time t7 to time t10 shown in FIG. 13, and a mode in which the control circuits 100 and 200 control the ejecting module 32 and the drive signal output circuit 50 in the cycle defined by the internal timing signal iPTS corresponding to the clock signal CLK, as in a period from time t1 to time t6 and a period from time t11 to time t14 shown in FIG. 13. In the liquid ejecting apparatus 1 and the head unit 5 of the present embodiment, when the timing signal PTS is not input for a predetermined period in the mode in which the control circuits 100 and 200 control the ejecting module 32 and the drive signal output circuit 50 in the cycle defined by the timing signal PTS corresponding to the encoder signal ENC, as in the period from time t10 to time t11 in FIG. 13, the control circuits 100 and 200 transition to the mode in which the control circuits 100 and 200 control the ejecting module 32 and the drive signal output circuit 50 in the cycle defined by the internal timing signal iPTS corresponding to the clock signal CLK. When the timing signal PTS is input in the mode in which the control circuits 100 and 200 control the ejecting module 32 and the drive signal output circuit 50 in the cycle defined by the internal timing signal iPTS corresponding to the clock signal CLK, as in the period from time t5 to time t7 in FIG. 13, the control circuits 100 and 200 transition to the mode in which the control circuits 100 and 200 control the ejecting module 32 and the drive signal output circuit 50 in the cycle defined by the timing signal PTS corresponding to the encoder signal ENC.

The control unit 2 is an example of an external controller. The piezoelectric element 60 is an example of a drive element. The ejecting module 32 is an example of an ejecting head. The liquid ejecting module 30 including the ejecting module 32 is another example of the ejecting head. The drive signal output circuit 50 is an example of a drive signal output circuit. The control circuits 100 and 200 are examples of a head control circuit. The relay unit 10 including the control circuit 100, and the head drive module 20 including the control circuit 200 are other examples of the head control circuit. The drive signals COMA, COMB, and COMC are examples of a drive signal. The voltage Vos is an example of a first voltage value. The voltage Vc is an example of a second voltage value. The timing signal PTS is an example of an ejection timing signal. The internal timing signal iPTS is an example of an internal ejection timing signal. The mode in which the control circuits 100 and 200 control the ejecting module 32 and the drive signal output circuit 50 in the cycle defined by the timing signal PTS corresponding to the encoder signal ENC is an example of a first mode. The mode in which the control circuits 100 and 200 control the ejecting module 32 and the drive signal output circuit 50 in the cycle defined by the internal timing signal iPTS corresponding to the clock signal CLK is an example of a second mode. The drive control signal Wno including the waveform selection information wn=[0xF] output by the control unit 2 is an example of a start request. Time t0 is an example of a first timing. Time t3 is an example of a second timing. Time t5 is an example of a third timing. Time t8 is an example of a fourth timing. Time t11 is an example of a fifth timing. Time t12 is an example of a sixth timing. The buffer period Pbuff is an example of a buffer period.

### 4. Operations and Effects

As described above, in the liquid ejecting apparatus 1 and the head unit 5 of the present embodiment, the control circuits 100 and 200 have the mode in which the control circuits 100 and 200 control the ejecting module 32 and the drive signal output circuit 50 in the cycle defined by the timing signal PTS corresponding to the encoder signal ENC, and the mode in which the control circuits 100 and 200 control the ejecting module 32 and the drive signal output circuit 50 in the cycle defined by the internal timing signal iPTS corresponding to the clock signal CLK.

Accordingly, during a period in which the timing signal PTS corresponding to the encoder signal ENC is not output, which is a period in which the liquid ejecting apparatus 1 does not form an image on the medium P, each head unit 5 executes, for example, the sequence control in synchronization with the internally generated signal for defining the operation timing. Accordingly, the processing load of the control unit 2 can be reduced.

Furthermore, in the liquid ejecting apparatus 1 and the head unit 5 of the present embodiment, when the timing signal PTS is not input for a predetermined period in the mode in which the control circuits 100 and 200 control the ejecting module 32 and the drive signal output circuit 50 in the cycle defined by the timing signal PTS corresponding to the encoder signal ENC, the control circuits 100 and 200 transition to the mode in which the control circuits 100 and 200 control the ejecting module 32 and the drive signal output circuit 50 in the cycle defined by the internal timing signal iPTS corresponding to the clock signal CLK. When the timing signal PTS is input in the mode in which the control circuits 100 and 200 control the ejecting module 32 and the drive signal output circuit 50 in the cycle defined by the internal timing signal iPTS corresponding to the clock signal CLK, the control circuits 100 and 200 transition to the mode in which the control circuits 100 and 200 control the ejecting module 32 and the drive signal output circuit 50 in the cycle defined by the timing signal PTS corresponding to the encoder signal ENC.

Accordingly, even when the head unit 5 has the operation mode in which the head unit 5 individually executes the control in synchronization with the internally generated signal for defining the operation timing, operations can be easily switched, the control specifications of the control unit 2 do not need to be changed, and the versatility of the control unit 2 and the head unit 5 is less likely to decrease. Accordingly, even when the head unit 5 is configured to be attachable and interchangeable with respect to the liquid ejecting apparatus 1 and the control unit 2, the versatility of the control unit 2 and the head unit 5 is less likely to decrease.

While the embodiments and the modification example are described above, the present disclosure is not limited to such embodiments and can be embodied with various aspects without departing from its concept. For example, the above embodiments can be combined as appropriate.

The present disclosure includes substantially the same configurations (for example, configurations having the same functions, methods, and results, or configurations having the same objects and effects) as the configurations described in the embodiments. The present disclosure includes configurations obtained by replacing non-essential parts of the configurations described in the embodiments. The present disclosure also includes configurations that achieve the same operations and effects or configurations that can achieve the same objects as the configurations described in the embodiments. The present disclosure also includes configurations obtained by adding a well-known technology to the configurations described in the embodiments.

The following contents are derived from the above embodiments.

According to an aspect, there is provided a head unit coupled to an external controller that outputs an ejection timing signal, the head unit includes an ejecting head that includes a drive element driven in accordance with a drive signal and ejects a liquid by driving the drive element, a drive signal output circuit that outputs the drive signal, and a head control circuit that controls the ejecting head and the drive signal output circuit, in which the head control circuit has a first mode in which the head control circuit controls the ejecting head and the drive signal output circuit in a cycle defined by the ejection timing signal, and a second mode in which the head control circuit controls the ejecting head and the drive signal output circuit in a cycle defined by an internal ejection timing signal corresponding to a clock signal, when the ejection timing signal is not input for a predetermined period in the first mode, the head control circuit transitions to the second mode, and when the ejection timing signal is input in the second mode, the head control circuit transitions to the first mode.

According to the head unit, by providing the first mode in which the ejecting head and the drive signal output circuit are controlled in the cycle defined by the ejection timing signal, and the second mode in which the ejecting head and the drive signal output circuit are controlled in the cycle defined by the internal ejection timing signal corresponding to the clock signal, each head unit can execute, for example, an operation such as a sequence control in accordance with the internal ejection timing signal corresponding to the clock signal even during a period in which the ejection timing signal is not output. Accordingly, a processing load of the external controller to which the head unit is coupled can be reduced.

Furthermore, according to the head unit, a transition is made to the second mode when the ejection timing signal is not input for the predetermined period in the first mode, and a transition is made to the first mode when the ejection timing signal is input in the second mode. That is, the first mode and the second mode are switched in accordance with the ejection timing signal. Accordingly, even when the head unit has the first mode and the second mode described above, the mode switching can be easily performed. Accordingly, even when the head unit has the first mode and the second mode described above, control specifications of the external controller do not need to be changed. Thus, versatility of the external controller and the head unit is less likely to decrease.

In the aspect of the head unit, at a first timing when a start request for the ejecting head to operate is input from the external controller, the head control circuit may control the drive signal output circuit to output the drive signal having a voltage value that changes from a first voltage value to a second voltage value higher than the first voltage value, in the cycle defined by the internal ejection timing signal, and at a second timing when the voltage value of the drive signal reaches the second voltage value after the first timing, the head control circuit may control the drive signal output circuit to output the drive signal including a microvibration waveform for driving the drive element not to eject the liquid from the ejecting head in the cycle defined by the internal ejection timing signal.

In the aspect of the head unit, at a third timing when input of the ejection timing signal starts after the second timing, the head control circuit may control the drive signal output circuit to output the drive signal including the microvibration waveform in the cycle defined by the ejection timing signal, and at a fourth timing after a predetermined period elapses from the third timing, the head control circuit may control the drive signal output circuit to output the drive signal including a drive waveform for driving the drive element to eject the liquid from the ejecting head in the cycle defined by the ejection timing signal.

In the aspect of the head unit, during a buffer period after the third timing, the head control circuit may control the drive signal output circuit to stop outputting the drive signal including the microvibration waveform in the cycle defined by the internal ejection timing signal, and after the buffer period elapses, the head control circuit may control the drive signal output circuit to start outputting the drive signal including the microvibration waveform in the cycle defined by the ejection timing signal.

According to the head unit, signals are less likely to interfere when a mode transition is made between the first mode in which the ejecting head and the drive signal output circuit are controlled in the cycle defined by the ejection timing signal and the second mode in which the ejecting head and the drive signal output circuit are controlled in the cycle defined by the internal ejection timing signal corresponding to the clock signal.

In the aspect of the head unit, at a fifth timing when the ejection timing signal is not input for a predetermined period after the fourth timing, the head control circuit may control the drive signal output circuit to output the drive signal including the microvibration waveform in the cycle defined by the internal ejection timing signal, and at a sixth timing after a predetermined period elapses from the fifth timing, the head control circuit may control the drive signal output circuit to output the drive signal having a voltage value that changes from the second voltage value to the first voltage value, in the cycle defined by the internal ejection timing signal.

According to the head unit, a voltage having an unintended potential is less likely to be applied to the drive element during a period in which an operation of the head unit stops.

According to another aspect, a liquid ejecting apparatus includes a control unit that outputs an ejection timing signal, and a head unit coupled to the control unit, in which the head unit includes an ejecting head that includes a drive element driven in accordance with a drive signal and ejects a liquid by driving the drive element, a drive signal output circuit that outputs the drive signal, and a head control circuit that controls the ejecting head and the drive signal output circuit, the head control circuit has a first mode in which the head control circuit controls the ejecting head and the drive signal output circuit in a cycle defined by the ejection timing signal, and a second mode in which the head control circuit controls the ejecting head and the drive signal output circuit in a cycle defined by an internal ejection timing signal corresponding to a clock signal, when the ejection timing signal is not input for a predetermined period in the first mode, the head control circuit transitions to the second mode, and when the ejection timing signal is input in the second mode, the head control circuit transitions to the first mode.

According to the liquid ejecting apparatus, by providing the head unit with the first mode in which the ejecting head and the drive signal output circuit are controlled in the cycle defined by the ejection timing signal, and the second mode in which the ejecting head and the drive signal output circuit are controlled in the cycle defined by the internal ejection timing signal corresponding to the clock signal, each head unit can execute, for example, an operation such as a sequence control in accordance with the internal ejection timing signal corresponding to the clock signal even during a period in which the ejection timing signal is not output. Accordingly, a processing load of the control unit to which the head unit is coupled can be reduced.

Furthermore, according to the liquid ejecting apparatus, a transition is made to the second mode when the ejection timing signal is not input for the predetermined period in the first mode, and a transition is made to the first mode when the ejection timing signal is input in the second mode. That is, the first mode and the second mode are switched in accordance with the ejection timing signal. Accordingly, even when the head unit has the first mode and the second mode described above, the mode switching can be easily performed. Accordingly, even when the head unit has the first mode and the second mode described above, control specifications of the control unit do not need to be changed. Thus, versatility of the control unit and the head unit is less likely to decrease.

In the aspect of the liquid ejecting apparatus, at a first timing when a start request for the ejecting head to operate is input from the control unit, the head control circuit may control the drive signal output circuit to output the drive signal having a voltage value that changes from a first voltage value to a second voltage value higher than the first voltage value, in the cycle defined by the internal ejection timing signal, and at a second timing when the voltage value of the drive signal reaches the second voltage value after the first timing, the head control circuit may control the drive signal output circuit to output the drive signal including a microvibration waveform for driving the drive element not to eject the liquid from the ejecting head in the cycle defined by the internal ejection timing signal.

In the aspect of the liquid ejecting apparatus, at a third timing when input of the ejection timing signal starts after the second timing, the head control circuit may control the drive signal output circuit to output the drive signal including the microvibration waveform in the cycle defined by the ejection timing signal, and at a fourth timing after a predetermined period elapses from the third timing, the head control circuit may control the drive signal output circuit to output the drive signal including a drive waveform for driving the drive element to eject the liquid from the ejecting head in the cycle defined by the ejection timing signal.

In the aspect of the liquid ejecting apparatus, during a buffer period after the third timing, the head control circuit may control the drive signal output circuit to stop outputting the drive signal including the microvibration waveform in the cycle defined by the internal ejection timing signal, and after the buffer period elapses, the head control circuit may control the drive signal output circuit to start outputting the drive signal including the microvibration waveform in the cycle defined by the ejection timing signal.

According to the liquid ejecting apparatus, signals are less likely to interfere when a mode transition is made between the first mode in which the ejecting head and the drive signal output circuit are controlled in the cycle defined by the ejection timing signal and the second mode in which the ejecting head and the drive signal output circuit are controlled in the cycle defined by the internal ejection timing signal corresponding to the clock signal.

In the aspect of the liquid ejecting apparatus, at a fifth timing when the ejection timing signal is not input for a predetermined period after the fourth timing, the head control circuit may control the drive signal output circuit to output the drive signal including the microvibration waveform in the cycle defined by the internal ejection timing signal, and at a sixth timing after a predetermined period elapses from the fifth timing, the head control circuit may control the drive signal output circuit to output the drive signal having a voltage value that changes from the second voltage value to the first voltage value, in the cycle defined by the internal ejection timing signal.

According to the liquid ejecting apparatus, a voltage having an unintended potential is less likely to be applied to the drive element during a period in which an operation of the liquid ejecting apparatus stops.

In the aspect of the liquid ejecting apparatus, the ejecting head may constitute a line head that extends in a width direction of a medium.

According to the liquid ejecting apparatus, even when the ejecting head constitutes a line head, the processing load of the control unit to which the head unit is coupled can be reduced.

What is claimed is:

1. A head unit coupled to an external controller that outputs an ejection timing signal, the head unit comprising:
an ejecting head that includes a drive element driven in accordance with a drive signal and ejects a liquid by driving the drive element;
a drive signal output circuit that outputs the drive signal; and
a head control circuit that controls the ejecting head and the drive signal output circuit, wherein
the head control circuit has
a first mode in which the head control circuit controls the ejecting head and the drive signal output circuit in a cycle defined by the ejection timing signal, and
a second mode in which the head control circuit controls the ejecting head and the drive signal output circuit in a cycle defined by an internal ejection timing signal corresponding to a clock signal,
when the ejection timing signal is not input for a predetermined period in the first mode, the head control circuit transitions to the second mode, and
when the ejection timing signal is input in the second mode, the head control circuit transitions to the first mode.

2. The head unit according to claim 1, wherein
at a first timing when a start request for the ejecting head to operate is input from the external controller, the head control circuit controls the drive signal output circuit to output the drive signal having a voltage value that changes from a first voltage value to a second voltage value higher than the first voltage value, in the cycle defined by the internal ejection timing signal, and
at a second timing when the voltage value of the drive signal reaches the second voltage value after the first timing, the head control circuit controls the drive signal output circuit to output the drive signal including a microvibration waveform for driving the drive element not to eject the liquid from the ejecting head in the cycle defined by the internal ejection timing signal.

3. The head unit according to claim 2, wherein
at a third timing when input of the ejection timing signal starts after the second timing, the head control circuit controls the drive signal output circuit to output the drive signal including the microvibration waveform in the cycle defined by the ejection timing signal, and
at a fourth timing after a predetermined period elapses from the third timing, the head control circuit controls the drive signal output circuit to output the drive signal including a drive waveform for driving the drive element to eject the liquid from the ejecting head in the cycle defined by the ejection timing signal.

4. The head unit according to claim 3, wherein
in a buffer period after the third timing, the head control circuit controls the drive signal output circuit to stop outputting the drive signal including the microvibration waveform in the cycle defined by the internal ejection timing signal, and
after the buffer period elapses, the head control circuit controls the drive signal output circuit to start outputting the drive signal including the microvibration waveform in the cycle defined by the ejection timing signal.

5. The head unit according to claim 3, wherein
at a fifth timing when the ejection timing signal is not input for a predetermined period after the fourth timing, the head control circuit controls the drive signal output circuit to output the drive signal including the microvibration waveform in the cycle defined by the internal ejection timing signal, and
at a sixth timing after a predetermined period elapses from the fifth timing, the head control circuit controls the drive signal output circuit to output the drive signal having a voltage value that changes from the second voltage value to the first voltage value, in the cycle defined by the internal ejection timing signal.

6. A liquid ejecting apparatus comprising:
a control unit that outputs an ejection timing signal; and
a head unit coupled to the control unit, wherein
the head unit includes
an ejecting head that includes a drive element driven in accordance with a drive signal and ejects a liquid by driving the drive element,
a drive signal output circuit that outputs the drive signal, and
a head control circuit that controls the ejecting head and the drive signal output circuit,
the head control circuit has
a first mode in which the head control circuit controls the ejecting head and the drive signal output circuit in a cycle defined by the ejection timing signal, and
a second mode in which the head control circuit controls the ejecting head and the drive signal output circuit in a cycle defined by an internal ejection timing signal corresponding to a clock signal,
when the ejection timing signal is not input for a predetermined period in the first mode, the head control circuit transitions to the second mode, and
when the ejection timing signal is input in the second mode, the head control circuit transitions to the first mode.

7. The liquid ejecting apparatus according to claim 6, wherein
at a first timing when a start request for the ejecting head to operate is input from the control unit, the head control circuit controls the drive signal output circuit to output the drive signal having a voltage value that changes from a first voltage value to a second voltage value higher than the first voltage value, in the cycle defined by the internal ejection timing signal, and
at a second timing when the voltage value of the drive signal reaches the second voltage value after the first timing, the head control circuit controls the drive signal output circuit to output the drive signal including a microvibration waveform for driving the drive element not to eject the liquid from the ejecting head in the cycle defined by the internal ejection timing signal.

8. The liquid ejecting apparatus according to claim 7, wherein
at a third timing when input of the ejection timing signal starts after the second timing, the head control circuit controls the drive signal output circuit to output the drive signal including the microvibration waveform in the cycle defined by the ejection timing signal, and
at a fourth timing after a predetermined period elapses from the third timing, the head control circuit controls the drive signal output circuit to output the drive signal including a drive waveform for driving the drive element to eject the liquid from the ejecting head in the cycle defined by the ejection timing signal.

9. The liquid ejecting apparatus according to claim 8, wherein
in a buffer period after the third timing, the head control circuit controls the drive signal output circuit to stop outputting the drive signal including the microvibration waveform in the cycle defined by the internal ejection timing signal, and
after the buffer period elapses, the head control circuit controls the drive signal output circuit to start outputting the drive signal including the microvibration waveform in the cycle defined by the ejection timing signal.

10. The liquid ejecting apparatus according to claim 8, wherein
at a fifth timing when the ejection timing signal is not input for a predetermined period after the fourth timing, the head control circuit controls the drive signal output circuit to output the drive signal including the microvibration waveform in the cycle defined by the internal ejection timing signal, and
at a sixth timing after a predetermined period elapses from the fifth timing, the head control circuit controls the drive signal output circuit to output the drive signal having a voltage value that changes from the second voltage value to the first voltage value, in the cycle defined by the internal ejection timing signal.

11. The liquid ejecting apparatus according to claim 10, wherein
the ejecting head constitutes a line head that extends in a width direction of a medium.
